(19) United States
(12) Patent Application Publication
(10) Pub. No.: US 2025/0368546 A1
(43) Pub. Date: Dec. 4, 2025

(54) GEOTHERMAL POWER GENERATION SYSTEM

(71) Applicant: FUJI ELECTRIC CO., LTD., Kanagawa (JP)

(72) Inventors: Azusa OZAWA, Tokyo (JP); Shinya UI, Tokyo (JP); Taku FUKUMURA, Kanagawa (JP)

(21) Appl. No.: 19/247,434

(22) Filed: Jun. 24, 2025

Related U.S. Application Data
(63) Continuation of application No. PCT/JP2024/024563, filed on Jul. 8, 2024.

(30) Foreign Application Priority Data
Jul. 19, 2023 (JP) 2023-117851

(51) Int. Cl. C02F 1/00; C02F 1/20; C02F 1/66; C02F 1/68; C02F 9/00; C02F 103/34; F03G 4/00; F24T 10/10; H02K 7/18

(52) U.S. Cl. CPC C02F 1/008; C02F 9/00; F24T 10/10; H02K 7/1823; C02F 1/20; C02F 1/66; C02F 1/685; C02F 2103/34; C02F 2201/005; C02F 2209/02; C02F 2209/06; C02F 2209/40; C02F 2303/22; F03G 4/069

(57) ABSTRACT

A geothermal power generation system according to an embodiment of the present invention includes: gas-liquid separator; first pipe; first valve to open and close a flow path of the first pipe; second pipe; analyzer; controller to determine at least one chemical agent from a plurality of chemical agent candidates based on an analysis result of the analyzer and control supply of the chemical agent; chemical agent supply port provided in the first pipe, to which the chemical agent is supplied; third pipe branched from the second pipe; chemical agent recovery line branched from and connected to the second pipe; provided in order from an upstream side of the chemical agent recovery line, waste liquid recovery section; scale separator; first chemical agent recovery section; impurity separator; second chemical agent recovery section; chemical agent purifier; recycled chemical agent tank; and waste liquid adjusting device.

### CROSS-REFERENCE TO RELATED APPLICATIONS

This application is a continuation application of International Application No. PCT/JP2024/024563, filed on Jul. 8, 2024, and designated in the U.S., which is based upon and claims priority to Japanese Patent Application No. 2023-117851, filed on Jul. 19, 2023, the entire contents of which are incorporated herein by reference.

### BACKGROUND

### 1. Field of the Invention

The present disclosure relates to a geothermal power generation system.

### 2. Description of the Related Art

The geothermal power generation system extracts a high-temperature geothermal fluid (geothermal brine and geothermal steam) from a production well, and generates power by using the geothermal brine or the geothermal steam separated from the geothermal fluid. The geothermal fluid extracted from the production well contains more calcium, dissolved silica, etc., than well water and river water.

Dissolved silica in the geothermal brine collected from the production well is concentrated by decompression in the geothermal power generation system, and it is cooled as it flows through piping, and its solubility decreases. Then, when the silica, the dissolved silica, and the like in the geothermal brine are supersaturated, they polymerize into amorphous silica, and precipitate as scale. Adhesion of the scale inside the piping is an issue in the geothermal power generation system, because the scale adhered to an inner wall or the like of the piping may cause an issue such as blockage of the piping.

Traditionally, in the geothermal power generation systems, studies have been conducted to remove scale by supplying chemical agents to the piping. For example, in a geothermal power generation system disclosed in Japanese Laid-Open Patent Application No. 2015-90147, a hydrogen peroxide solution is supplied to the geothermal brine as an oxidizing agent to prevent scale adhesion of silica components in a geothermal brine system.

### SUMMARY

An aspect of the present disclosure provides a geothermal power generation system provided with a binary power generator including a medium evaporator, comprising:
a gas-liquid separator configured to separate geothermal brine from a geothermal fluid spouted out from a production well;
a first pipe configured to send the geothermal brine separated by the gas-liquid separator to the medium evaporator;
a first valve provided in the first pipe and configured to open and close a flow path of the first pipe;
a second pipe configured to send the geothermal brine, from which heat has been recovered by the binary power generator, from the medium evaporator to a re-injection well;
an analyzer configured to intake the geothermal brine flowing through the second pipe and analyze components of scale contained in the geothermal brine that is incoming;
a controller configured to determine at least one chemical agent from a plurality of chemical agent candidates based on an analysis result of the analyzer and control supply of the chemical agent;
a chemical agent supply port provided in the first pipe on a downstream side relative to the first valve, to which the chemical agent is supplied;
a third pipe branched from the second pipe;
a chemical agent recovery line branched from the second pipe on the downstream side relative to the third pipe and connected to the second pipe;
a waste liquid recovery section provided in the chemical agent recovery line in order from an upstream side of the chemical agent recovery line, and configured to store a waste liquid after cleaning the first pipe and the second pipe;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate the secondary chemical-agent-containing substance into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier.

Another aspect of the present disclosure is a geothermal power generation system including:
a gas-liquid separator configured to separate geothermal brine and geothermal steam from a geothermal fluid spouted out from a production well;
a power generator configured to generate power by using the geothermal brine or the geothermal steam separated by the gas-liquid separator as a heat source;
a retention tank configured to store the geothermal brine, from which heat has been recovered by the power generator;
a re-injection line configured to connect an outlet of the retention tank and the re-injection well;
a re-injection pump provided in the re-injection line and configured to return the geothermal brine discharged from the retention tank to the re-injection well;
a chemical agent injection port provided in the re-injection line between the retention tank and the re-injection pump;
a first chemical agent adding device configured to inject a chemical agent into the chemical agent injection port;
a branching section provided in the re-injection line on the downstream side relative to the re-injection pump and on an upper side in a vertical direction relative to the re-injection well, and configured to branch a flow of the geothermal brine;
a first liquid analyzer connected on an upper side in a vertical direction from the branching section;
a scale-piece collector connected in a horizontal direction from the branching section and including a residue input port, a dissolving agent injection port, and a residue discharge port;
a dissolving agent adding device configured to inject a dissolving agent into the dissolving agent injection port;
a controller configured to switch between an injection operation and injection stoppage of the chemical agent performed by the first chemical agent adding device and switch between the injection operation and injection stoppage of the dissolving agent performed by the dissolving agent adding device, based on an analysis result of the first liquid analyzer;
a chemical agent recovery line branched from a pipe connecting the dissolving agent injection port and the dissolving agent adding device and connected to a pipe connecting the branching section and the re-injection well;
a waste liquid recovery section provided in the chemical agent recovery line in order from an upstream side of the chemical agent recovery line, and configured to store a waste liquid after cleaning the re-injection line;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate the secondary chemical-agent-containing substance into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust the temperature of fluid contained in the scale separator, the impurity separator, or the chemical agent purifier, wherein
the waste liquid adjusting device is connected to at least one of the scale separator, the impurity separator, or the chemical agent purifier.

Another aspect of the present disclosure provides a geothermal power generation system including:
a gas-liquid separator configured to separate geothermal brine and geothermal steam from a geothermal fluid spouted out from a production well;
a power generator configured to generate power by using the geothermal brine or the geothermal steam separated by the gas-liquid separator as a heat source;
a retention tank configured to store the geothermal brine from which heat has been recovered by the power generator;
a re-injection line configured to connect an outlet of the retention tank and a re-injection well;
a re-injection pump provided in the re-injection line and configured to return the geothermal brine discharged from the retention tank to the re-injection well;
a chemical agent injection port provided in the re-injection line between the retention tank and the re-injection pump;
a first chemical agent adding device configured to inject a chemical agent into the chemical agent injection port;
a branching section provided in the re-injection line on the downstream side relative to the re-injection pump and on an upper side in a vertical direction relative to the re-injection well, and configured to branch a flow of the geothermal brine;
a first liquid analyzer connected on an upper side in the vertical direction from the branching section;
a scale-piece collector connected in a horizontal direction from the branching section and including a residue input port, a dissolving agent injection port, and a residue discharge port;
a dissolving agent adding device configured to inject a dissolving agent into the dissolving agent injection port;
a controller configured to switch between an injection operation and injection stoppage of the chemical agent performed by the first chemical agent adding device, and switch between the injection operation and injection stoppage of the dissolving agent performed by the dissolving agent adding device, based on an analysis result of the first liquid analyzer;
a first bypass pipe branched from the re-injection line and connected to the re-injection line on the downstream side relative to the re-injection pump;
a second bypass pipe branched from the re-injection line and connected to the re-injection line on the downstream side relative to the first bypass pipe;
a first switching valve provided in the re-injection line and configured to switch a flow path of the re-injection line to the first bypass pipe;
a second switching valve provided in the re-injection line and configured to switch the flow path of the re-injection line to the second bypass pipe;
a chemical agent adjusting section provided in the first bypass pipe;
a first partition valve provided in the first bypass pipe on an upstream side relative to the chemical agent adjusting section;
a second partition valve provided in the first bypass pipe on a downstream side relative to the chemical agent adjusting section;
a second chemical agent adding device configured to inject a chemical agent into the chemical agent adjusting section;
an air introducing device configured to supply air to the chemical agent in the chemical agent adjusting section;
a chemical agent collecting section provided in the second bypass pipe;
a third partition valve provided in the second bypass pipe on the upstream side relative to the chemical agent collecting section;
a fourth partition valve provided in the second bypass pipe on the downstream side relative to the chemical agent collecting section;
a second liquid analyzer connected to the chemical agent collecting section;
a chemical agent recovery line branched from the second bypass pipe and connected to a pipe connecting the branching section and the re-injection well;
a waste liquid recovery section provided in the chemical agent recovery line in order from an upstream side of the chemical agent recovery line, and configured to store a waste liquid after cleaning the re-injection line;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate it into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust the temperature of fluid contained in the scale separator, the impurity separator, or the chemical agent purifier, wherein
the waste liquid adjusting device is connected to at least one of the scale separator, the impurity separator, or the chemical agent purifier, and
a controller is configured to switch between the injection operation and injection stoppage of the chemical agent performed by the second chemical agent adding device, and between allowing air introduction and stopping air introduction performed by the air introducing device based on an analysis result of the second liquid analyzer, as well as to control the first switching valve, the second switching valve, and the first partition valve to the fourth partition valve.

### BRIEF DESCRIPTION OF THE DRAWINGS

FIG. 1 is a schematic configurational diagram illustrating a geothermal power generation system according to a first embodiment;

FIG. 2 is a schematic diagram illustrating a separation vessel;

FIG. 3 is a flow diagram illustrating how cleaning according to the first embodiment is performed;

FIG. 4 is a schematic configurational diagram illustrating a chemical agent recovery line in the geothermal power generation system according to the first embodiment;

FIG. 5 is a schematic configurational diagram illustrating a geothermal power generation system according to a second embodiment;

FIG. 6 is a time chart illustrating an operation of cleaning in the geothermal power generation system according to the second embodiment;

FIG. 7 is a schematic configurational diagram illustrating a chemical agent recovery line in the geothermal power generation system according to the second embodiment;

FIG. 8 is a schematic configurational diagram illustrating a geothermal power generation system according to a third embodiment;

FIG. 9 is an enlarged view illustrating main components of FIG. 8;

FIG. 10A is an enlarged view illustrating the main components of FIG. 8 for explaining the operation of cleaning in the geothermal power generation system according to the third embodiment;

FIG. 10B is an enlarged view illustrating the main components of FIG. 8 for explaining the operation of cleaning in the geothermal power generation system according to the third embodiment;

FIG. 10C is an enlarged view illustrating the main components of FIG. 8 for explaining the operation of cleaning in the geothermal power generation system according to the third embodiment;

FIG. 10D is an enlarged view illustrating the main components of FIG. 8 for explaining the operation of cleaning in the geothermal power generation system according to the third embodiment;

FIG. 10E is an enlarged view illustrating the main components of FIG. 8 for explaining the operation of cleaning in the geothermal power generation system according to the third embodiment; and

FIG. 11 is a time chart illustrating the operation of cleaning in the geothermal power generation system according to the third embodiment.

### DETAILED DESCRIPTION OF THE PRESENT DISCLOSURE

In an existing geothermal power generation system, the scale may remain in the geothermal power generation system even after cleaning is performed, and in order to sufficiently remove the remaining scale, the amount of the chemical agent used in the cleaning needs to be increased.

An aspect of the present disclosure is to provide a geothermal power generation system configured to sufficiently clean away the scale and recover the chemical agent used in the cleaning from the geothermal power generation system.

Hereinafter, embodiments of the present disclosure will be described with reference to the drawings.

### First Embodiment

A geothermal power generation system 1 according to a first embodiment will be described. First, a configuration of the geothermal power generation system 1 for cleaning will be described.

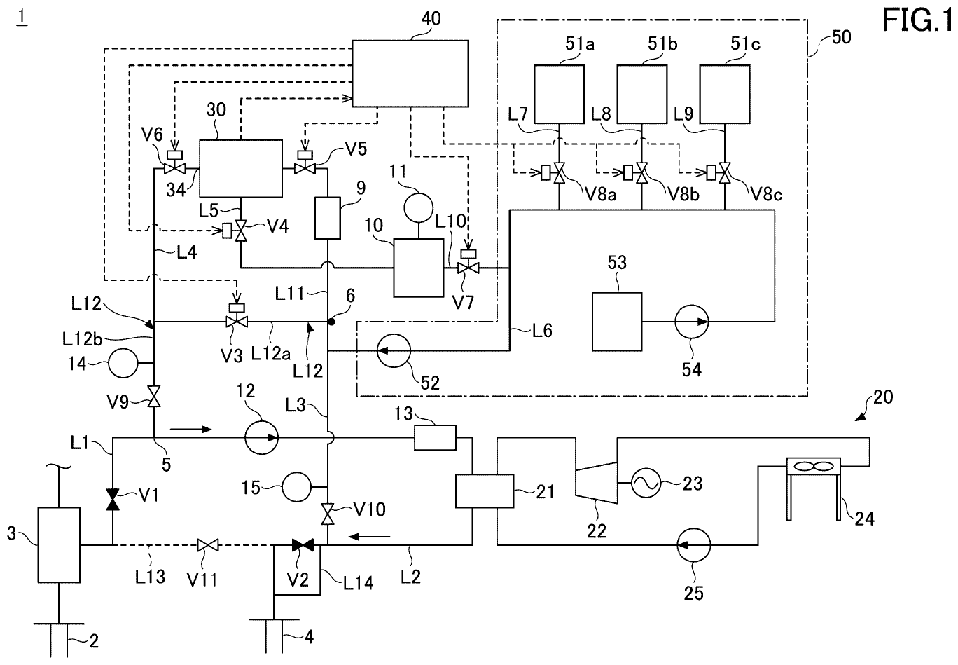

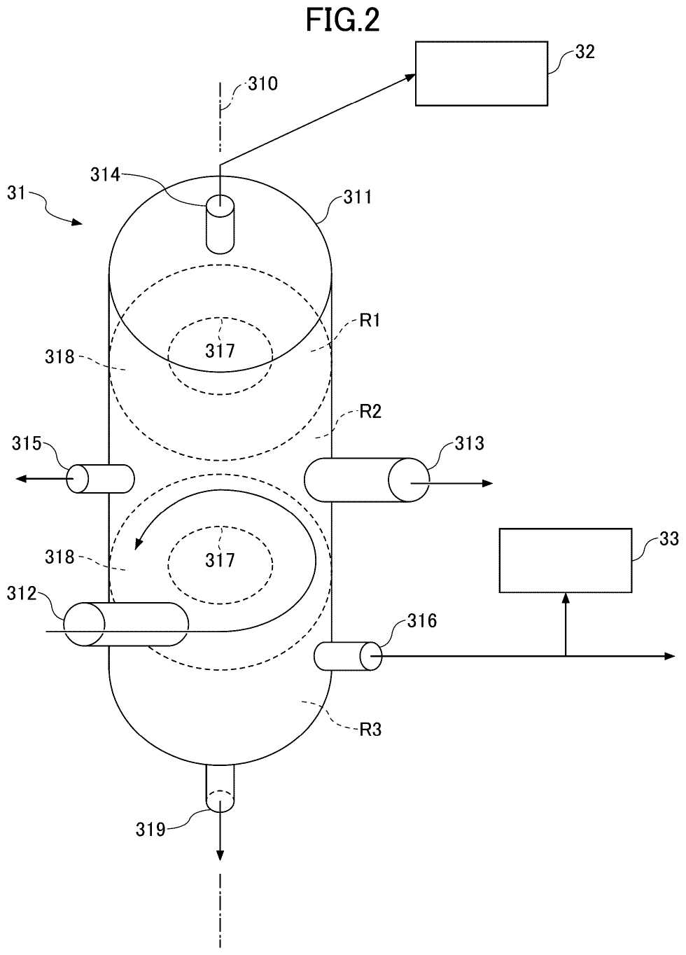

FIG. 1 is a schematic configurational diagram illustrating a geothermal power generation system according to the first embodiment, and FIG. 2 is a schematic diagram illustrating a separation vessel. As illustrated in FIG. 1, a geothermal power generation system 1 includes a binary power generator 20 provided with a medium evaporator 21. Furthermore, the geothermal power generation system 1 includes a gas-liquid separator 3, a first pipe L1 configured to send the geothermal brine separated by the gas-liquid separator 3 to the medium evaporator 21, a first valve V1 provided inside the first pipe L1 to open and close a flow path of the first pipe L1, and a second pipe L2 configured to send the geothermal brine, from which heat has been recovered by the binary power generator 20, from the medium evaporator 21 to a re-injection well 4.

Furthermore, the geothermal power generation system 1 includes an analyzer 30, a controller 40. and on the downstream side relative to the first valve, a chemical agent supply port 5 provided in the first pipe L1 and configured to supply a chemical agent (detergent).

The geothermal power generation system 1 performs binary power generation in the binary power generator 20 by utilizing the heat of the geothermal brine separated by the gas-liquid separator 3. In the geothermal power generation system 1, geothermal fluid collected from a production well 2 is sent to the gas-liquid separator 3. The gas-liquid separator 3 separates the geothermal brine from the geothermal fluid spouted out from the production well 2. The geothermal brine separated by the gas-liquid separator 3 is sent to the medium evaporator 21 via the first pipe L1, where heat is exchanged to evaporate a low-boiling-point heat medium, and then returned to the re-injection well 4 via the second pipe L2. When a chemical agent is supplied from a chemical agent supply port 5, the geothermal brine (waste liquid generated after cleaning) containing the chemical agent flowing through the first pipe L1 and the second pipe L2 is returned to the re-injection well 4 via a chemical agent recovery line L14 described in the following.

The heat medium vaporized by the medium evaporator 21 is sent to a turbine 22 via a pipe, and power is generated by a power generator 23. Furthermore, the heat medium that has passed through the turbine 22 is sent to a medium condenser 24 via a pipe, where it becomes a condensate and is returned to the medium evaporator 21 via a pipe including therein a pump 25.

The heat medium used in the binary power generator 20 is a low-boiling-point heat medium that can be vaporized by utilizing the heat of the geothermal brine separated by the gas-liquid separator 3. Examples of the heat medium include, but are not limited to, normalheptane, isoheptane, normalpentane, isopentane, normalbutane, isobutane, hydrofluoroether, 1,1,1,3,3-pentafluoropropane (R245fa), 1,1,1,2-tetrafluoroethane (R134a), chlorodifluoromethane (R22), as well as a mixture of difluoromethane, 1,1,1,2-pentafluoroethane, and 1,1,1,2-tetrafluoroethane (R407c).

In contrast to this, the geothermal steam separated by the gas-liquid separator 3 may be sent to a turbine (not illustrated) and power may be generated by a power generator connected to the turbine. In this case, the gas-liquid separator 3 has a function of a flasher to decompress the geothermal brine and extract the geothermal steam. That is, the geothermal power generation system 1 may include a flash power generator (not illustrated) connected to the gas-liquid separator 3 and the binary power generator 20.

The geothermal power generation system 1 may include a thirteenth pipe L13 branched from the first pipe L1 and connected to the re-injection well 4, and a bypass valve V11 provided inside the thirteenth pipe L13.

The geothermal power generation system 1 may include a second valve V2 provided inside the second pipe L2 and configured to open and close a flow path of the second pipe L2, a third pipe L3 connected to the second pipe L2 on an upstream side relative to the second valve V2, and a branching section 6 configured to branch the flow of the geothermal brine or the chemical agent flowing through the third pipe L3 into an analysis line L11 connected to the analyzer 30 and a chemical agent supply line L12 connected to the chemical agent supply port 5. The geothermal power generation system 1 may also include a chemical agent adding device 50 configured to add a chemical agent to the geothermal brine flowing through the third pipe L3. FIG. 1 is a diagram illustrating a state in which the first valve V1 and the second valve V2 are closed.

An inner diameter of the analysis line L11 is smaller than the inner diameter of the chemical agent supply line L12. Thus, the geothermal brine of an appropriate flow rate for analysis, which is smaller than the flow rate of the geothermal brine flowing into the analysis line L11, can be introduced into the analyzer 30 via the analysis line L11, and the chemical agent of the flow rate necessary for cleaning can be introduced into the chemical agent supply line L12.

The geothermal power generation system 1 may include a circulation pump 12 provided inside the first pipe L1 on the downstream side relative to the chemical agent supply port 5. The circulation pump 12 has a function of sending the geothermal brine separated by the gas-liquid separator 3 to the second pipe L2 during ordinary operation (during power generation), and has a function of circulating the chemical agent supplied from the chemical agent supply port 5, together with the geothermal brine, into the flow path including the first pipe L1, the second pipe L2, the third pipe L3, and the chemical agent supply line L12 during cleaning performed after the ordinary operation (after stoppage of the power generation).

It is preferable that the geothermal power generation system 1 further includes a third valve V3 provided in the chemical agent supply line L12 and configured to open and close the flow path of the chemical agent supply line L12. Specifically, the chemical agent supply line L12 includes a first chemical agent supply line L12a which branches from the branching section 6, and a second chemical agent supply line L12b which has one end connected to the first chemical agent supply line L12a and the other end connected to the chemical agent supply port 5. The third valve V3 is provided in the first chemical agent supply line L12a.

The geothermal power generation system 1 may include a fourth pipe L4 having one end connected to a first outlet 34 of the analyzer 30 and the other end connected to the second chemical agent supply line L12b, and configured to circulate the geothermal brine discharged from the analyzer 30.

The analyzer 30 takes in the geothermal brine flowing through the second pipe L2, and analyzes scale components contained in the inflow geothermal brine. Examples of the scale components contained in the geothermal brine include amorphous silica, calcium carbonate, ooze containing organic matter, iron rust, and the like.

As illustrated in FIG. 2, the analyzer 30 may include a separation vessel 31 configured to separate solid substances, liquid, and gas contained in the geothermal brine flowing into the analyzer 30, a gas analyzer 32 configured to analyze the separated gas from the separation vessel 31, and a liquid analyzer 33 configured to analyze the separated liquid from the separation vessel 31.

The separation vessel 31 may separate solid substances, liquid, and gas contained in the geothermal brine by generating a swirling flow inside the separation vessel 31. In FIG. 2, the flow of solid substances, liquid, and gas contained in the geothermal brine is indicated by arrows. Specifically, the separation vessel 31 may include a housing 311 having a cylindrical shape and arranged such that an axis 310 of the housing 311 is at an angle within a range of 0° or more and less than 90° with respect to a vertical direction, a geothermal brine inlet 312 provided on a side surface of the housing 311 and through which the geothermal brine flows in, and a geothermal brine outlet 313 through which the geothermal brine is discharged.

The geothermal brine inlet 312 is connected to the analysis line L11, and the geothermal brine outlet 313 is connected to the fourth pipe L4. The geothermal power generation system 1 may include a fifth valve V5 provided in the analysis line L11 to open and close the flow path of the analysis line L11, and a sixth valve V6 provided inside the fourth pipe L4 to open and close a flow path of the fourth pipe L4.

The geothermal power generation system 1 may include a flowmeter 9 provided in the analysis line L11 and configured to measure the flow rate of geothermal brine flowing into the analyzer 30.

The inside of the separation vessel 31 may be divided into three chambers. For example, the separation vessel 31 may include a first chamber R1, a second chamber R2, and a third chamber R3 arranged adjacently from an upper side in the vertical direction. The first chamber R1, the second chamber R2, and the third chamber R3 communicate with each other at their central portions. Specifically, the separation vessel 31 may include two partitions 318 including an opening 317 at each center, and the partitions 318 may be spaced apart from each other along the axis 310 inside the housing 311. A central axis of the opening 317 coincides with the axis 310 of the housing 311. The partition 318 may be, for example, a baffle.

The first chamber R1 includes on an upper surface of the first chamber R1 a gas outlet 314 for discharging the separated gas. The second chamber R2 includes on a side surface thereof a first solid-substance outlet 315 for discharging the separated solid substances. The third chamber R3 includes on a lower surface thereof, that is a bottom surface of the separation vessel 31, a second solid-substance outlet 319 for discharging the separated solid substances, and includes on a side surface thereof a liquid outlet 316 for discharging the separated liquid.

The solid substances discharged from the first solid-substance outlet 315 include solid substances having a relatively large mass such as, for example, rock fragments and iron rust, and the solid substances discharged from the second solid-substance outlet 319 include solid substances having a smaller mass than the solid substances discharged from the first solid-substance outlet 315, such as ooze and colloids.

The geothermal brine inlet 312 and the geothermal brine outlet 313 are provided on the side surface of the second chamber R2, and the geothermal brine inlet 312 is arranged on a lower side relative to the geothermal brine outlet 313 in a vertical direction. With the above configuration, the separation vessel 31 can separate solid substances, liquid, and gas contained in the geothermal brine by generating a swirling flow inside the separation vessel 31.

The gas analyzer 32 is connected to the gas outlet 314 of the separation vessel 31. The gas analyzer 32 measures, for example, the concentration of oxygen and the concentration of carbon dioxide.

The liquid analyzer 33 is connected to the liquid outlet 316 of the separation vessel 31. The liquid analyzer 33 measures, for example, the pH, a dielectric constant, and the dissolved ion concentration.

The separation vessel 31 has the function of separating solid substances, liquid, and gas contained in the geothermal brine as described above, and also has the function of collecting or depositing scales in the separation vessel 31 for analysis. Therefore, in order to accelerate the collection or the deposition of scales in the separation vessel 31, the separation vessel 31 may include a metal mesh, ceramic beads, or the like inside.

As illustrated in FIG. 1, the geothermal power generation system 1 may include a recovery tank 10 connected to the first solid-substance outlet 315 (see FIG. 2) and the second solid-substance outlet 319 (see FIG. 2) of the analyzer 30 and accommodating solid substances discharged from the first solid-substance outlet 315 and the second solid-substance outlet 319.

The geothermal power generation system 1 may include a fourth valve V4 provided in a flow path connecting the first solid-substance outlet 315 and the second solid-substance outlet 319 to the recovery tank 10. Specifically, the geothermal power generation system 1 may include a fifth pipe L5 connecting the first solid-substance outlet 315 and the second solid-substance outlet 319 to the inlet of the recovery tank 10, and a fourth valve V4 provided inside the fifth pipe L5 to open and close the flow path of the fifth pipe L5. The solid substances discharged from the first solid-substance outlet 315 and the second solid-substance outlet 319 flow into and are accommodated in the recovery tank 10 via the fifth pipe L5.

The recovery tank 10 may include a water level meter 11. Thus, the amount of solid substances accommodated in the recovery tank 10 can be detected, and when the amount detected by the water level meter 11 reaches a specified value, the solid substances in the recovery tank 10 can be disposed of.

The controller 40 determines at least one chemical agent (detergent) from a plurality of chemical agent (detergent) candidates, based on the analysis result of the analyzer 30, and controls the supply of the chemical agent (detergent). The plurality of chemical agent candidates can be, for example, chemical agents containing two or more agents selected from a group including acidic agents, basic agents, chelating agents, hydrogen peroxide agents, dispersants, and catalase agents.

The acidic agents can be used to dissolve calcium-based scales. Examples of the acidic agents include sulfuric acid, hydrochloric acid, acetic acid, citric acid, and the like. The basic agents can be used to dissolve silica-based scales (amorphous silica). Examples of the basic agents include sodium hydroxide, potassium hydroxide, ammonium salts, and the like. The chelating agents can be used to perform masking of dissolved metals in the geothermal brine and to suppress waste of other chemical agents before using other chemical agents under pH control. Examples of the chelating agents include ethylenediaminetetraacetic acid (EDTA), nitrilotriacetic acid (NTA), hydroxyethylenediaminetriacetic acid (HEDTA), diethylenetriaminepentaacetic acid (DTPA), trimethanolamine, sodium gluconate, and the like. Hydrogen peroxide agents can be used to dissolve ooze. For example, hydrogen peroxide solution is used as the hydrogen peroxide agent. The dispersant can be used to disperse and peel off the scale adhered to an inner wall or the like of piping. For example, sodium polyacrylate, various surfactants, and the like are used as the dispersant. The catalase agent can be used to decompose the hydrogen peroxide agent remaining in the geothermal brine after using the hydrogen peroxide agent.

Specifically, the controller 40 determines at least one chemical agent from a plurality of chemical agent candidates, based on the gas analysis result of the analyzer 30, and controls the supply of the chemical agent. For example, the controller 40 determines that the main component of the scale is ooze when the concentration of oxygen detected by the gas analyzer 32 after introducing the hydrogen peroxide agent into the separation vessel 31 of the analyzer 30 and reacting the hydrogen peroxide agent with the scale deposited in the separation vessel 31 is equal to or greater than a specified value, and determines that the main component of the scale is calcium carbonate or amorphous silica when the concentration of oxygen detected by the gas analyzer 32 is equal to or less than the specified value. When the main component of the scale is determined to be calcium carbonate or amorphous silica, the controller 40 determines that the main component of the scale is calcium carbonate when the concentration of carbon dioxide detected by the gas analyzer 32 is equal to or greater than the specified value after introducing the acidic agent into the separation vessel 31 and reacting the acidic agent with the scale deposited in the separation vessel 31, and determines that the main component of the scale is amorphous silica or iron rust when the concentration of carbon dioxide detected by the gas analyzer 32 is equal to or less than the specified value. The optimum chemical agent is determined for the main component of the scale determined as described above from the plurality of chemical agent candidates.

Before determining the chemical agent, the controller 40 may cause the analysis line L11 and the analyzer 30 to take-in the geothermal brine with the fourth valve V4 closed and to collect the separated solid substances in the separation vessel 31, and then may close the first valve V1, the second valve V2, and the third valve V3, and may cause the chemical agent adding device 50 to supply the acidic agent or the hydrogen peroxide agent to the analysis line L11, and the analyzer 30 may analyze the gas generated by the chemical reaction of the solid substance with respect to the acidic agent or the hydrogen peroxide agent. Furthermore, when the main component of the scale is ooze, the controller 40 may select the hydrogen peroxide agent as a first chemical agent to be used, and may select a chemical agent other than the hydrogen peroxide agent as a second chemical agent to be used. When the main component of the scale is calcium carbonate, the controller 40 may select the acidic agent as the first chemical agent to be used, and may select a chemical agent other than the acidic agent as the second chemical agent to be used.

The chemical agent adding device 50 may include a plurality of chemical agent tanks 51a, 51b, and 51c each configured to accommodate one of a plurality of chemical agent candidates, a chemical agent injection pump 52 configured to introduce the chemical agent into the third pipe L3, a water tank 53 arranged on an upstream side relative to the plurality of chemical agent tanks 51a, 51b, and 51c and configured to store water, and a liquid feed pump 54 configured to introduce the water into the third pipe L3. The number of the chemical agent tanks 51a, 51b, and 51c is three in the example as illustrated in FIG. 1, but is not limited thereto, and may be four or more depending on the number of chemical agent candidates.

The water stored in the water tank 53 may be water for washing away the chemical agent remaining in a sixth pipe L6 when changing the type of chemical agent to be introduced to the third pipe L3, and may be, for example, one kind selected from a group including tap water, river water, and distilled water.

The chemical agent adding device 50 may include the sixth pipe L6 that connects an outlet port of the liquid feed pump 54 and an inlet port of the chemical agent injection pump 52, a seventh pipe L7 that is branched from the sixth pipe L6 and connected to an outlet of the chemical agent tank 51a, an eighth pipe L8 that is branched from the sixth pipe L6 and connected to an outlet of the chemical agent tank 51b, and a ninth pipe L9 that is branched from the sixth pipe L6 and connected to an outlet of the chemical agent tank 51c. The chemical agent adding device 50 may include an eighth valve V8a provided inside the seventh pipe L7 to open and close a flow path of the seventh pipe L7, an eighth valve V8b provided inside the eighth pipe L8 to open and close a flow path of the eighth pipe L8, and an eighth valve V8c provided inside the ninth pipe L9 to open and close a flow path of the ninth pipe L9.

On the downstream side relative to the seventh pipe L7, the eighth pipe L8, and the ninth pipe L9, the chemical agent adding device 50 may include a tenth pipe L10 connected to a chemical agent inlet of the recovery tank 10, and a seventh valve V7 provided inside the tenth pipe L10 to open and close a flow path of the tenth pipe L10. The chemical agent adding device 50 can introduce the chemical agent into the chemical agent inlet of the recovery tank 10 via the tenth pipe L10. The solid substances contained in the recovery tank 10 can be dissolved by introducing the chemical agent from the chemical agent inlet of the recovery tank 10. The chemical agent introduced from the chemical agent inlet of the recovery tank 10 is preferably a chemical agent capable of dissolving solid substances such as ooze and colloids. Examples include hydrogen peroxide agents, basic agents, fluoride agents, and mixtures of chelating agents and basic agents. The basic agents and fluoride agents can be used to dissolve silica-based colloids. As the basic agent, the same chemical agents as the above-mentioned chemical agent candidates can be used. Examples of the fluoride agent include hydrofluoric acids. A mixture of a chelating agent and a basic agent can be used to dissolve calcium-based colloids. As the chelating agent, the same chemical agent as the chemical agent candidate can be used.

The recovery tank 10 may have a function of adjusting the pressure. Specifically, when excessive pressure exceeding a specified value is applied to the chemical agent injection pump 52 by the chemical agent or water flowing through the sixth pipe L6, the controller 40 sends a signal to the seventh valve V7 to open the seventh valve V7. Thus, the chemical agent or water flowing through the sixth pipe L6 can flow into the recovery tank 10 through the tenth pipe L10, thereby reducing the pressure on the chemical agent injection pump 52.

The geothermal power generation system 1 is preferably provided with a heater or a heat exchanger or the like from the viewpoint of enhancing the advantageous effect of the chemical agent by raising the temperature of the fluid when the temperature of the geothermal brine to which the chemical agent is to be added drops or the like. The heater or the heat exchanger may be provided, for example, inside the first pipe L1 on the downstream side relative to the chemical agent supply port 5.

The controller 40 may be configured to determine a cleaning state based on an analysis result of the components contained in the fluid analyzed by the analyzer 30, after distributing the fluid, which is obtained by adding the chemical agent to the geothermal brine flowing through the third pipe L3 by the chemical agent adding device 50, through the chemical agent supply line L12, the first pipe L1, the second pipe L2, and the third pipe L3. As the cleaning proceeds, the inner wall of the piping is exposed, and the iron of the piping dissolves into the fluid, and thus, the concentration of iron ions contained in the fluid increases. Therefore, the analysis result of the components contained in the fluid analyzed by the analyzer 30 may be the concentration of the iron ions. For example, the controller 40 may determine that the cleaning is complete when the concentration of the iron ions reaches 100 ppm. The analysis result of the components contained in the fluid analyzed by the analyzer 30 may be a dielectric constant.

The geothermal power generation system 1 includes a pressure gauge 14 provided inside the second chemical agent supply line L12b and a pressure gauge 15 provided inside the third pipe L3. The controller 40 may determine that the cleaning is complete when a differential pressure between the pressure detected by the pressure gauge 14 and the pressure detected by the pressure gauge 15 becomes less than or equal to a specified value. When the scale adheres to the inner walls of the first pipe L1 and the second pipe L2, a cross-sectional area of a flow path decreases in both the first pipe L1 and the second pipe L2. Therefore, the state of the cleaning can be determined based on the differential pressure between the pressure gauge 14 located on the upstream side relative to both the first pipe L1 and the second pipe L2 and the pressure gauge 15 located on the downstream side relative to both the first pipe L1 and the second pipe L2.

The geothermal power generation system 1 includes a flowmeter 13 provided inside the first pipe L1 on the downstream side relative to the circulation pump 12. The controller 40 may determine that the cleaning is complete when the flow rate detected by the flowmeter 13 reaches the flow rate occurring at the start of operation (start of power generation) or a specified flow rate.

The geothermal power generation system 1 may include a ninth valve V9 provided inside the second chemical agent supply line L12b and a tenth valve V10 provided inside the third pipe L3. The ninth valve V9 and the tenth valve V10 may be flow adjustment valves.

The controller 40 can control each of the first valve V1 to the seventh valve V7, the eighth valves V8a, V8b, and V8c, the ninth valve V9, the tenth valve V10, and the bypass valve V11, and can switch the flow path in the geothermal power generation system 1 or control the flow rate of the fluid flowing through the flow path.

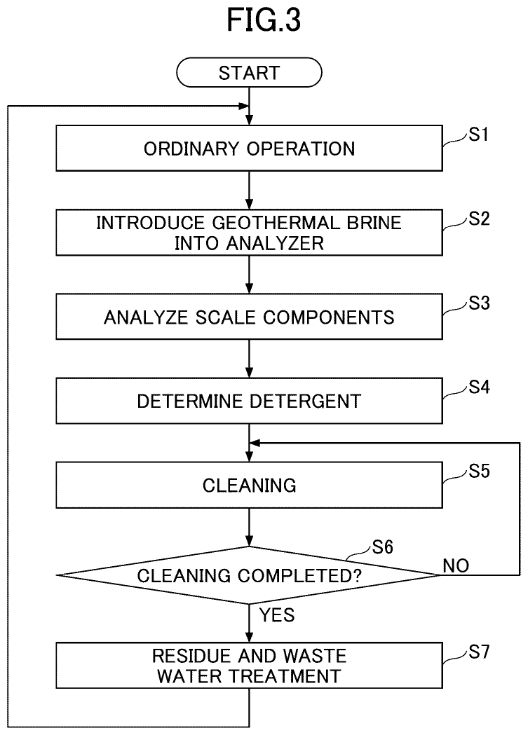

FIG. 3 is a flow diagram illustrating how cleaning according to the first embodiment is performed. As illustrated in FIG. 3, a method for cleaning the scale in the geothermal power generation system 1 includes performing an ordinary operation (step S1), introducing the geothermal brine into the analyzer 30 after the ordinary operation (step S2), analyzing scale components contained in the introduced geothermal brine by the analyzer 30 (step S3), determining at least one chemical agent (detergent) from a plurality of chemical agent (detergent) candidates, based on an analysis result of the analyzer 30 (step S4), and cleaning the first pipe L1 and the second pipe L2 by supplying the determined chemical agent from the chemical agent supply port 5 (step S5).

In the method of cleaning the scale in the geothermal power generation system 1, step S3 is preferably performed 2 to 3 weeks after the start of step S2, in order to collect or deposit the scale required for the analysis in step S3, inside the analyzer 30.

The method for cleaning the scale in the geothermal power generation system 1 further includes determining (step S6) whether or not the cleaning is complete (cleaning state) based on the analysis result of the analyzer 30, which is obtained by introducing the fluid (including the geothermal brine and the chemical agent) after cleaning the first pipe L1 and the second pipe L2 into the analyzer 30 and analyzing the components contained in the introduced fluid by the analyzer 30. When the cleaning is determined to be complete (“YES” in step S6), a treatment of residues and waste water (step S7) is performed and a process flow returns to the ordinary operation (step S1). When the cleaning is determined not to be complete (“NO” in step S6), the process flow returns to step S5 and the steps S5 and S6 may be repeated until the cleaning is determined to be complete.

The geothermal power generation system 1 recovers the chemical agent from the waste liquid generated after cleaning in the process of treating residues and waste water, and then returns impurities and the like taken out in the process of purifying the chemical agent to the re-injection well 4 after the treatment. The geothermal power generation system 1 also recovers residues that cannot be returned to the re-injection well 4 and discards them as industrial waste.

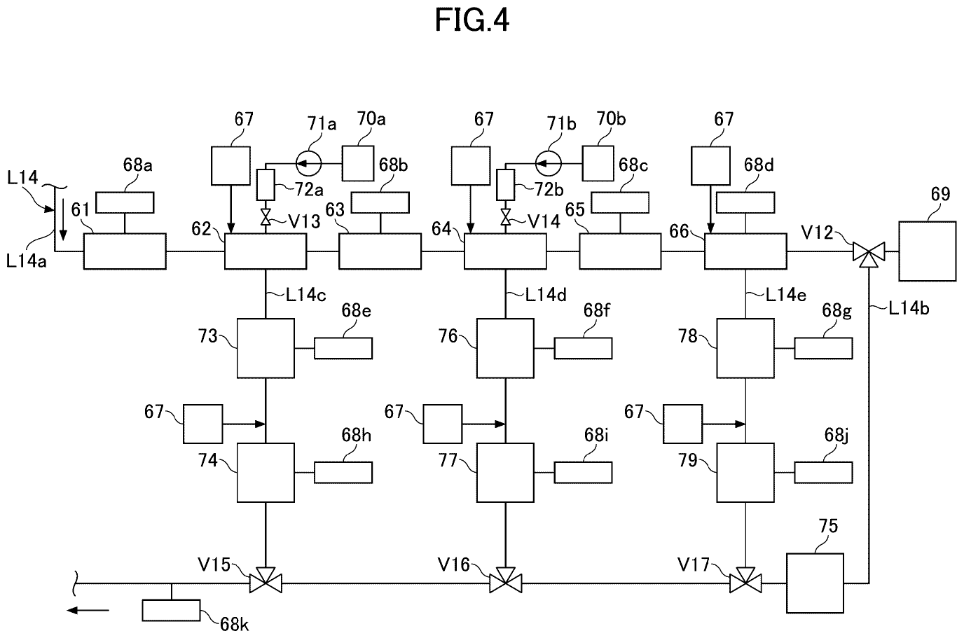

Next, the configuration for recovering a chemical agent in the geothermal power generation system 1 will be described. FIG. 4 is a schematic configurational diagram illustrating the chemical agent recovery line L14 in the geothermal power generation system 1 according to the first embodiment. As illustrated in FIG. 4, the geothermal power generation system 1 includes the chemical agent recovery line L14 branched from the second pipe L2 and connected to the second pipe L2 on the downstream side relative to the third pipe L3. Furthermore, the geothermal power generation system 1 includes a waste liquid recovery section 61, a scale separator 62, a first chemical agent recovery section 63, an impurity separator 64, a second chemical agent recovery section 65, a chemical agent purifier 66, and a recycled-chemical-agent tank 69, which are provided in the chemical agent recovery line L14 in order from the upstream side of the chemical agent recovery line L14, and a waste liquid adjusting device 67.

The chemical agent recovery line L14 may include a first chemical agent recovery line L14a configured to connect the waste liquid recovery section 61, the scale separator 62, the first chemical agent recovery section 63, the impurity separator 64, the second chemical agent recovery section 65, the chemical agent purifier 66, and the recycled-chemical-agent tank 69, and a second chemical agent recovery line L14b branched from the first chemical agent recovery line L14a between the chemical agent purifier 66 and the recycled-chemical-agent tank 69. The chemical agent recovery line L14 may include a third chemical agent recovery line L14c branched from the second chemical agent recovery line L14b and connected to the chemical agent purifier 66, a fourth chemical agent recovery line L14d branched from the second chemical agent recovery line L14b and connected to the impurity separator 64, and a fifth chemical agent recovery line L14e branched from the second chemical agent recovery line L14b and connected to the chemical agent purifier 66.

The waste liquid, after the cleaning is performed, that flows into the chemical agent recovery line L14 is purified as it passes through the waste liquid recovery section 61, the scale separator 62, the first chemical agent recovery section 63, the impurity separator 64, the second chemical agent recovery section 65, and the chemical agent purifier 66, and the recycled chemical agent purified from the waste liquid is contained in the recycled-chemical-agent tank 69. Impurities and the like taken out in the process of purifying the waste liquid into the recycled chemical agent are adjusted and returned to the re-injection well 4 from the second chemical agent recovery line L14b through the third chemical agent recovery line L14c, the fourth chemical agent recovery line L14d, and the fifth chemical agent recovery line L14e.

The waste liquid recovery section 61 stores waste liquid after cleaning the first pipe L1 and the second pipe L2.

The scale separator 62 separates the waste liquid into a scale-containing substance and a primary chemical-agent-containing substance. The scale-containing substance is a solid or a liquid, and the primary chemical-agent-containing substance is a liquid containing the chemical agent supplied from the chemical agent supply port 5. That is, the scale separator 62 may separate the waste liquid into a solid and a liquid, or a liquid and a liquid. The scale separator 62 may be, for example, a filtering device, a retention tank, a centrifuge, or a reactor. The retention tank stores the waste liquid, advances polymerization reaction of silica in the waste liquid, and retains the waste liquid until the silica insoluble component sufficiently coagulates and precipitates. The reactor is a container for chemically reacting the waste liquid.

The first chemical agent recovery section 63 stores the primary chemical-agent-containing substance separated by the scale separator 62.

The impurity separator 64 separates the primary chemical-agent-containing substance discharged from the first chemical agent recovery section 63 into a primary impurity and a secondary chemical-agent-containing substance. The secondary chemical-agent-containing substance is a liquid containing the chemical agent supplied from the chemical agent supply port 5, and the concentration of the chemical agent in the secondary chemical-agent-containing substance is higher than the concentration of the chemical agent in the primary chemical-agent-containing substance. The impurity separator 64 may be, for example, a reactor, a distillator such as a fractioning device, or an extractor.

The second chemical agent recovery section 65 stores the secondary chemical-agent-containing substance separated by the impurity separator 64.

The chemical agent purifier 66 purifies the secondary chemical-agent-containing substance discharged from the second chemical agent recovery section 65 and separates it into a secondary impurity and a recycled chemical agent. The recycled chemical agent is a liquid containing the chemical agent supplied from the chemical agent supply port 5, and the concentration of the recycled chemical agent is higher than the concentration of the chemical agent in the secondary chemical-agent-containing substance. The chemical agent purifier 66 may be, for example, a reactor, a distillator such as a fractioning device, or an extractor.

The recycled-chemical-agent tank 69 stores the recycled chemical agent. The recycled-chemical-agent tank 69 may be connected to the sixth pipe L6 on the upstream side relative to the chemical agent injection pump 52. Thus, the geothermal power generation system 1 can supply the recycled chemical agent from the chemical agent supply port 5 and reuse the chemical agent.

The waste liquid adjusting device 67 supplies a silica concentration adjusting agent, a pH adjusting agent, or an ion concentration adjusting agent, or adjusts the temperature of the fluid contained in the scale separator 62, the impurity separator 64, and the chemical agent purifier 66. The waste liquid adjusting device 67 may include a plurality of tanks each containing the silica concentration adjusting agent, the pH adjusting agent, or the ion concentration adjusting agent, a plurality of pumps each connected to a corresponding tank and configured to discharge the silica concentration adjusting agent, the pH adjusting agent, or the ion concentration adjusting agent, respectively, and a flowmeter provided on the downstream side relative to the pump. The waste liquid adjusting device 67 may include a heating and cooling device. The waste liquid adjusting device 67 can precipitate dissolved silica as a silica scale and separate the silica scale by lowering the temperature of the fluid, for example. The geothermal power generation system 1 may include a plurality of controllers 40, and the waste liquid adjusting device 67 may include the controller 40.

Examples of the silica concentration adjusting agent include water glass or silicates such as sodium silicate and sodium silicate hexahydrate. Examples of the pH adjusting agent include sulfuric acid, hydrochloric acid, nitric acid, sodium hydroxide, sodium carbonate, sodium bicarbonate, and the like. Examples of the ion concentration adjusting agent include sodium carbonate, sodium bicarbonate, sodium sulfate, sodium chloride, sodium hydroxide, and the like. The waste liquid adjusting device 67 may include, for example, an ion separation membrane, an ion exchange resin, and the like.

The waste liquid adjusting device 67 is connected to each of the scale separator 62, the impurity separator 64, and the chemical agent purifier 66. In the example as illustrated in FIG. 4, the number of waste liquid adjusting devices 67 is more than one, but may be one. The waste liquid adjusting device 67 supplies a silica concentration adjusting agent, a pH adjusting agent, or an ion concentration adjusting agent to the scale separator 62, or adjusts the temperature of the fluid contained in the scale separator 62. Additionally, the waste liquid adjusting device 67 supplies a silica concentration adjusting agent, a pH adjusting agent, or an ion concentration adjusting agent to the impurity separator 64, or adjusts the temperature of the primary chemical-agent-containing substance contained in the impurity separator 64. Furthermore, the waste liquid adjusting device 67 supplies a silica concentration adjusting agent, a pH adjusting agent, or an ion concentration adjusting agent to the chemical agent purifier 66, or adjusts the temperature of the secondary chemical-agent-containing substance contained in the chemical agent purifier 66.

The geothermal power generation system 1 may include a first analyzer 68a connected to the waste liquid recovery section 61 and configured to measure the temperature, the pH, a dielectric constant, or a dissolved ion concentration of the waste liquid contained in the waste liquid recovery section 61. The controller 40 may cause the waste liquid adjusting device 67 to supply a silica concentration adjusting agent, a pH adjusting agent, or an ion concentration adjusting agent to the scale separator 62 based on the measurement result of the first analyzer 68a, or cause the waste liquid adjusting device 67 to adjust the temperature of the waste liquid contained in the scale separator 62. The controller 40 may calculate, for example, based on the measurement result of the first analyzer 68a, the concentration of a silica concentration adjusting agent, a pH adjusting agent, or an ion concentration adjusting agent necessary for separating the waste liquid into the scale-containing substance and the primary chemical-agent-containing substance, convert the calculated concentration into a flow rate, and send a command to the pump of the waste liquid adjusting device 67 to discharge the agent at the determined flow rate. The controller 40 may calculate, for example, based on the measurement result of the first analyzer 68a, the temperature necessary for separating the waste liquid into the scale-containing substance and the primary chemical-agent-containing substance, and sends a command to the heating and cooling device of the waste liquid adjusting device 67 to adjust the temperature to the calculated temperature.

The geothermal power generation system 1 may include a flocculant tank 70a configured to contain a flocculant, a flocculant pump 71a configured to introduce the flocculant into the scale separator 62, a flowmeter 72a configured to measure a flow rate of the flocculant, and an eleventh valve V13 provided on the downstream side relative to the flocculant tank 70a, the flocculant pump 71a, and the flowmeter 72a and configured to open and close a flow path through which the flocculant flows, connected to the scale separator 62. Based on the measurement result of the first analyzer 68a, the controller 40 may send a command to the flocculant pump 71a to discharge the flocculant. Examples of the flocculant include solutions containing silica, calcium, aluminum, iron, and the like.

The geothermal power generation system 1 may include a second analyzer 68b connected to the first chemical agent recovery section 63 and configured to measure the temperature, the pH, a dielectric constant, or a dissolved ion concentration of the primary chemical-agent-containing substance contained in the first chemical agent recovery section 63. Based on the measurement result of the second analyzer 68b, the controller 40 may cause the waste liquid adjusting device 67 to supply the silica concentration adjusting agent, the pH adjusting agent, or the ion concentration adjusting agent to the impurity separator 64, or cause the waste liquid adjusting device 67 to adjust the temperature of the primary chemical-agent-containing substance contained in the impurity separator 64. The controller 40 may, for example, calculate the concentration of the silica concentration adjusting agent, pH adjusting agent, or ion concentration adjusting agent necessary for separating the primary chemical-agent-containing substance into a primary impurity and a secondary chemical-agent-containing substance based on the measurement result of the second analyzer 68b, convert the calculated concentration into a flow rate, and send a command to the pump of the waste liquid adjusting device 67 to discharge the agent at the predetermined flow rate.

The geothermal power generation system 1 may include a dispersant tank 70b which is connected to the impurity separator 64 and configured to contain a dispersant, a dispersant pump 71b which introduces the dispersant into the impurity separator 64, a flowmeter 72b configured to measure a flow rate of the dispersant, and a twelfth valve V14 provided on the downstream side relative to the dispersant tank 70b, the dispersant pump 71b, and the flowmeter 72b and configured to open and close the flow path through which the dispersant flows. The controller 40 may send a command to the dispersant pump 71b to discharge the dispersant based on the measurement result of the second analyzer 68b. Examples of the dispersant include sodium polyacrylate and various surfactants.

The geothermal power generation system 1 may include a third analyzer 68c connected to the second chemical agent recovery section 65 and configured to measure the temperature, the pH, a dielectric constant, or a dissolved ion concentration of the secondary chemical agent contained in the second chemical agent recovery section 65. Based on a measurement result of the third analyzer 68c, the controller 40 may cause the waste liquid adjusting device 67 to supply a silica concentration adjusting agent, a pH adjusting agent, or an ion concentration adjusting agent to the chemical agent purifier 66, or cause the waste liquid adjusting device 67 to adjust the temperature of the secondary chemical-agent-containing substance contained in the chemical agent purifier 66.

The geothermal power generation system 1 may include a fourth analyzer 68d connected to the chemical agent purifier 66 and configured to measure the concentration of the recycled chemical agent purified in the chemical agent purifier 66. The geothermal power generation system 1 may also include a first three-way valve V12 provided at the branching point between the first chemical agent recovery line L14a and the second chemical agent recovery line L14b, and configured to switch between a state in which the chemical agent purifier 66 communicates with the recycled-chemical-agent tank 69 and a state in which the chemical agent purifier 66 communicates with the second chemical agent recovery line L14b. Then, the controller 40 may control the first three-way valve V12 such that the chemical agent purifier 66 communicates with the recycled-chemical-agent tank 69 when the concentration of the recycled chemical agent measured by the fourth analyzer 68d reaches a specified value and it is determined that the purification of the chemical agent is complete. Specifically, the controller 40 may control the first three-way valve V12 such that the chemical agent purifier 66 communicates with the recycled-chemical-agent tank 69 when the concentration of the recycled chemical agent measured by the fourth analyzer 68d reaches the same concentration as the concentration of the corresponding chemical agent stored in the chemical agent tank 51a, 51b, or 51c before use.

The geothermal power generation system 1 may include a scale-containing substance recovery tank 73 provided in the third chemical agent recovery line L14c, a first adjusted-liquid tank 74, and a fifth analyzer 68e connected to the scale-containing substance recovery tank 73. The first adjusted-liquid tank 74 is provided on the downstream side relative to the scale-containing substance recovery tank 73. The waste liquid adjusting device 67 may be connected to the third chemical agent recovery line L14c between the scale-containing substance recovery tank 73 and the first adjusted-liquid tank 74.

The scale-containing substance recovery tank 73 is configured to store the scale-containing substance.

The first adjusted-liquid tank 74 is configured to store the scale-containing substance after the silica concentration, the pH, or the ion concentration is adjusted (adjusted scale-containing substance).

The fifth analyzer 68e is configured to measure the temperature, the pH, a dielectric constant, or a dissolved ion concentration of the scale-containing substance stored in the scale-containing substance recovery tank 73. Based on a measurement result of the fifth analyzer 68e, the controller 40 may cause the waste liquid adjusting device 67 to supply the silica concentration adjusting agent, pH adjusting agent, or ion concentration adjusting agent to the fluid (scale-containing substance) flowing through the third chemical agent recovery line L14c between the scale-containing substance recovery tank 73 and the first adjusted-liquid tank 74. The controller 40 calculates, for example, the concentration of the silica concentration adjusting agent, pH adjusting agent, or ion concentration adjusting agent necessary for returning the material to the re-injection well 4 based on the measurement result of the fifth analyzer 68e, converts the calculated concentration into a flow rate, and sends a command to the pump for discharging the silica concentration adjusting agent, the pH adjusting agent, or the ion concentration adjusting agent of the waste liquid adjusting device 67 to discharge the agent at the predetermined flow rate.

The geothermal power generation system 1 may include a primary-impurity recovery tank 76, a second adjusted-liquid tank 77, and a sixth analyzer 68f connected to the primary-impurity recovery tank 76, which are provided in the fourth chemical agent recovery line L14d. The second adjusted-liquid tank 77 is provided on the downstream side relative to the primary-impurity recovery tank 76. The waste liquid adjusting device 67 may be connected to the fourth chemical agent recovery line L14d between the primary-impurity recovery tank 76 and the second adjusted-liquid tank 77.

The primary-impurity recovery tank 76 is configured to store the primary impurity.

The second adjusted-liquid tank 77 is configured to store the primary impurity after the silica concentration, the pH, or the ion concentration is adjusted (adjusted primary impurity).

The sixth analyzer 68f is configured to measure the temperature, the pH, a dielectric constant, or the dissolved ion concentration of the primary impurity contained in the primary-impurity recovery tank 76. Based on the measurement result of the sixth analyzer 68f, the controller 40 may cause the waste liquid adjusting device 67 to supply the silica concentration adjusting agent, the pH adjusting agent, or the ion concentration adjusting agent to the fluid (primary impurity) flowing through the fourth chemical agent recovery line L14d between the primary-impurity recovery tank 76 and the second adjusted-liquid tank 77. For example, based on the measurement result of the sixth analyzer 68f, the controller 40 calculates the concentration of the silica concentration adjusting agent, pH adjusting agent, or ion concentration adjusting agent required to return the fluid to the re-injection well 4, converts the calculated concentration into a flow rate, and sends a command to the pump for discharging the silica concentration adjusting agent, the pH adjusting agent, or the ion concentration adjusting agent of the waste liquid adjusting device 67 to discharge the agent at the predetermined flow rate.

The geothermal power generation system 1 may include a secondary-impurity recovery tank 78 provided in the fifth chemical agent recovery line L14e, a third adjusted-liquid tank 79, and a seventh analyzer 68g connected to the secondary-impurity recovery tank 78. The third adjusted-liquid tank 79 is provided on the downstream side relative to the secondary-impurity recovery tank 78. The waste liquid adjusting device 67 may be connected to the fifth chemical agent recovery line L14e between the secondary-impurity recovery tank 78 and the third adjusted-liquid tank 79.

The secondary-impurity recovery tank 78 is configured to store the secondary impurity.

The third adjusted-liquid tank 79 is configured to store the secondary impurity after the silica concentration, the pH, or the ion concentration is adjusted (adjusted secondary impurity).

The seventh analyzer 68g is configured to measure the temperature, the pH, a dielectric constant, or the dissolved ion concentration of the secondary impurity stored in the secondary-impurity recovery tank 78. Based on the measurement result of the seventh analyzer 68g, the controller 40 may cause the waste liquid adjusting device 67 to supply the silica concentration adjusting agent, the pH adjusting agent, or the ion concentration adjusting agent to the fluid (secondary impurity) flowing through the fifth chemical agent recovery line L14e between the secondary-impurity recovery tank 78 and the third adjusted-liquid tank 79. For example, based on the measurement result of the seventh analyzer 68g, the controller 40 calculates the concentration of the silica concentration adjusting agent, pH adjusting agent, or ion concentration adjusting agent required for returning the fluid to the re-injection well 4, converts the calculated concentration into a flow rate, and sends a command to the pump for discharging the silica concentration adjusting agent, pH adjusting agent, or ion concentration adjusting agent of the waste liquid adjusting device 67 to discharge the agent at the predetermined flow rate.

The geothermal power generation system 1 may include a residue recovery tank 75 provided in the second chemical agent recovery line L14b.

The residue recovery tank 75 is provided on the upstream side relative to a branching point between the fifth chemical agent recovery line L14e and the second chemical agent recovery line L14b. The residue recovery tank 75 is configured to accommodate residues discharged from the first adjusted-liquid tank 74, the second adjusted-liquid tank 77, and the third adjusted-liquid tank 79. Here, the residue means the adjusted scale-containing substance, the adjusted primary impurity, or the adjusted secondary impurity that cannot be returned to the re-injection well 4 because its silica concentration, pH, or ion concentration is outside a specified range. The residue recovery tank 75 may also accommodate a recycled chemical agent when the recycled-chemical-agent tank 69 becomes full. In this case, the controller 40 switches the first three-way valve V12 such that the recycled-chemical-agent tank 69 communicates with the second chemical agent recovery line L14b.

The geothermal power generation system 1 may include an eighth analyzer 68h connected to the first adjusted-liquid tank 74, and a second three-way valve V15 provided at a branching point between the third chemical agent recovery line L14c and the second chemical agent recovery line L14b.

The eighth analyzer 68h is configured to measure the temperature, the pH, a dielectric constant, or a dissolved ion concentration of the adjusted scale-containing substance contained in the first adjusted-liquid tank 74.

The second three-way valve V15 is a valve configured to switch between a state in which the first adjusted-liquid tank 74 communicates with the re-injection well 4 and a state in which the first adjusted-liquid tank 74 communicates with the residue recovery tank 75. When the concentration of the adjusted scale-containing substance measured by the eighth analyzer 68h reaches a specified value, the controller 40 may control the second three-way valve V15 such that the first adjusted-liquid tank 74 communicates with the re-injection well 4.

The geothermal power generation system 1 may include a ninth analyzer 68i connected to the second adjusted-liquid tank 77, and a third three-way valve V16 provided at a branching point between the fourth chemical agent recovery line L14d and the second chemical agent recovery line L14b.

The ninth analyzer 68i is configured to measure the temperature, the pH, a dielectric constant, or a dissolved ion concentration of the adjusted primary impurity contained in the second adjusted-liquid tank 77.

The third three-way valve V16 is a valve that can be switched between a state in which the second adjusted-liquid tank 77 communicates with the re-injection well 4 and a state in which the second adjusted-liquid tank 77 communicates with the residue recovery tank 75. When the concentration of the adjusted primary impurity measured by the ninth analyzer 68i reaches a specified value, the controller 40 may control the third three-way valve V16 such that the second adjusted-liquid tank 77 communicates with the re-injection well 4.

The geothermal power generation system 1 may include a tenth analyzer 68j connected to the third adjusted-liquid tank 79 and a fourth three-way valve V17 provided at a branching point between the fifth chemical agent recovery line L14e and the second chemical agent recovery line L14b.

The tenth analyzer 68j is configured to measure the temperature, the pH, a dielectric constant, or a dissolved ion concentration of the adjusted secondary impurity contained in the third adjusted-liquid tank 79.

The fourth three-way valve V17 can be switched between a state in which the third adjusted-liquid tank 79 communicates with the re-injection well 4 and a state in which the third adjusted-liquid tank 79 communicates with the residue recovery tank 75. Then, the controller 40 may control the fourth three-way valve V17 such that the third adjusted-liquid tank 79 communicates with the re-injection well 4 when the concentration of the adjusted secondary impurity measured by the tenth analyzer 68j reaches a specified value.

The geothermal power generation system 1 is provided with the binary power generator 20 including the medium evaporator 21, and includes the gas-liquid separator 3, the first pipe L1, the first valve V1, the second pipe L2, the analyzer 30, the controller 40, the chemical agent supply port 5, the third pipe L3, the chemical agent recovery line L14, the waste liquid recovery section 61, the scale separator 62, the first chemical agent recovery section 63, the impurity separator 64, the second chemical agent recovery section 65, the chemical agent purifier 66, the recycled-chemical-agent tank 69, and the waste liquid adjusting device 67, and the waste liquid adjusting device 67 is connected to each of the scale separator 62, the impurity separator 64, and the chemical agent purifier 66.

With this configuration, the geothermal power generation system 1 can, in a state in which power generation is stopped by closing the first valve V1 and in a state in which the geothermal power generation system 1 is closed, that is, in a state not opened to an external environment or decomposed, supply the optimum chemical agent corresponding to the components of the scale from the chemical agent supply port 5, and distribute the chemical agent to the first pipe L1 and the second pipe L2 in which the scale particularly tends to adhere. Therefore, the geothermal power generation system 1 can remove the scale regardless of the components of the scale. Moreover, since the geothermal power generation system 1 can add a chemical agent to the geothermal brine having a relatively high temperature after power generation is stopped, and distribute the chemical agent to the first pipe L1 and the second pipe L2, the advantageous effect of the chemical agent can be enhanced. Furthermore, the waste liquid after cleaning the first pipe L1 and the second pipe L2 is adjusted by the waste liquid adjusting device 67 as the waste liquid flows through the waste liquid recovery section 61, the scale separator 62, the first chemical agent recovery section 63, the impurity separator 64, the second chemical agent recovery section 65, and the chemical agent purifier 66, such that the scale-containing substance and impurities are sequentially separated and removed, and thus the waste liquid is purified, and a recycled chemical agent is stored in the recycled-chemical-agent tank 69. Therefore, the geothermal power generation system 1 can recover the recycled chemical agent from the waste liquid by purifying the waste liquid. Thus, the geothermal power generation system 1 can sufficiently remove the scale and recover the chemical agent used for cleaning.

The geothermal power generation system 1 includes the first analyzer 68a, and based on the measurement result of the first analyzer 68a, the controller 40 causes the waste liquid adjusting device 67 to supply a silica concentration adjusting agent, a pH adjusting agent, or an ion concentration adjusting agent to the scale separator 62, or causes the waste liquid adjusting device 67 to adjust the temperature of the waste liquid contained in the scale separator 62.

According to the silica concentration, the pH, or the ion concentration of the waste liquid, the controller 40 causes the waste liquid adjusting device 67 to supply an appropriate amount of the silica concentration adjusting agent, pH adjusting agent, or ion concentration adjusting agent, or causes the waste liquid adjusting device 67 to adjust the temperature of the fluid to a predetermined temperature. Therefore, the scale-containing substance and the primary chemical-agent-containing substance can be sufficiently separated in the scale separator 62, and thus the chemical agent used for cleaning can be efficiently recovered.

The geothermal power generation system 1 includes the second analyzer 68b, and based on a measurement result of the second analyzer 68b, the controller 40 causes the waste liquid adjusting device 67 to supply the silica concentration adjusting agent, the pH adjusting agent, or the ion concentration adjusting agent to the impurity separator 64, or causes the waste liquid adjusting device 67 to adjust the temperature of the primary chemical-agent-containing substance contained in the impurity separator 64.

According to the silica concentration, the pH, or the ion concentration of the primary chemical-agent-containing substance, the controller 40 causes the waste liquid adjusting device 67 to supply an appropriate amount of the silica concentration adjusting agent, pH adjusting agent, or ion concentration adjusting agent, or causes the waste liquid adjusting device 67 to adjust the temperature of the primary chemical-agent-containing substance to a predetermined temperature. Therefore, the scale-containing substance and the primary chemical-agent-containing substance can be sufficiently separated in the impurity separator 64, and thus the chemical agent used for cleaning can be efficiently recovered.

The geothermal power generation system 1 is provided with the third analyzer 68c, and the controller 40 causes the waste liquid adjusting device 67 to supply a silica concentration adjusting agent, a pH adjusting agent, or an ion concentration adjusting agent to the chemical agent purifier 66 based on the measurement result of the third analyzer 68c, or causes the waste liquid adjusting device 67 to adjust the temperature of the secondary chemical-agent-containing substance contained in the chemical agent purifier 66.

With this configuration, the controller 40 causes the waste liquid adjusting device 67 to supply an appropriate amount of the silica concentration adjusting agent, pH adjusting agent, or ion concentration adjusting agent according to the silica concentration, the pH, or the ion concentration of the secondary chemical-agent-containing substance, or causes the waste liquid adjusting device 67 to adjust the temperature of the secondary chemical-agent-containing substance to the predetermined temperature according to the temperature of the secondary chemical-agent-containing substance. Therefore, the scale-containing substance and the secondary chemical-agent-containing substance can be sufficiently separated in the chemical agent purifier 66, and thus the chemical agent used for cleaning can be efficiently recovered.

In the geothermal power generation system 1, the chemical agent recovery line L14 includes the first chemical agent recovery line L14a, the second chemical agent recovery line L14b, the third chemical agent recovery line L14c, the fourth chemical agent recovery line L14d, and the fifth chemical agent recovery line L14e.

With this configuration, the recycled chemical agent purified from the waste liquid is stored in the recycled-chemical-agent tank 69 via the first chemical agent recovery line L14a, and the scale-containing substance, the primary impurity, and the secondary impurity separated in the process of purification are adjusted and then returned from the second chemical agent recovery line L14b to the re-injection well 4 via the third chemical agent recovery line L14c, the fourth chemical agent recovery line L14d, and the fifth chemical agent recovery line L14e. Therefore, the chemical agent used for cleaning can be efficiently recovered, and the scale-containing substance, the primary impurity, and the secondary impurity can be returned to the re-injection well 4.

The geothermal power generation system 1 includes the fourth analyzer 68d and the first three-way valve V12. The controller 40 controls the first three-way valve V12 such that the chemical agent purifier 66 communicates with the recycled-chemical-agent tank 69 when the concentration of the recycled chemical agent measured by the fourth analyzer 68d reaches the specified value and when it is determined that the purification is complete.

With this configuration, the geothermal power generation system 1 can sufficiently remove the scale even when the recycled chemical agent is used for cleaning.

The geothermal power generation system 1 includes the scale-containing substance recovery tank 73, the first adjusted-liquid tank 74, and the fifth analyzer 68e. The controller 40 causes the waste liquid adjusting device 67 to supply the silica concentration adjusting agent, the pH adjusting agent, or the ion concentration adjusting agent to the fluid flowing through the third chemical agent recovery line L14c between the scale-containing substance recovery tank 73 and the first adjusted-liquid tank 74 based on a measurement result of the fifth analyzer 68e.

With this configuration, the controller 40 can cause the waste liquid adjusting device 67 to supply an appropriate amount of the silica concentration adjusting agent, pH adjusting agent, or ion concentration adjusting agent according to the silica concentration, the pH, or the ion concentration of the scale-containing substance recovery tank 73. Therefore, the geothermal power generation system 1 can return the scale-containing substance to the re-injection well 4 after sufficiently adjusting it.

The geothermal power generation system 1 includes the primary-impurity recovery tank 76, the second adjusted-liquid tank 77, and the sixth analyzer 68f, and the controller 40 causes the waste liquid adjusting device 67 to supply the silica concentration adjusting agent, the pH adjusting agent, or the ion concentration adjusting agent to the fluid flowing through the fourth chemical agent recovery line L14d between the primary-impurity recovery tank 76 and the second adjusted-liquid tank 77 based on a measurement result of the sixth analyzer 68f.

With this configuration, the controller 40 can cause the waste liquid adjusting device 67 to supply an appropriate amount of the silica concentration adjusting agent, pH adjusting agent, or ion concentration adjusting agent according to the silica concentration, the pH, or the ion concentration of the primary-impurity recovery tank 76. Therefore, the geothermal power generation system 1 can return the primary impurity to the re-injection well 4 after sufficiently adjusting it.

The geothermal power generation system 1 includes the secondary-impurity recovery tank 78, the third adjusted-liquid tank 79, and the seventh analyzer 68g, and the controller 40 causes the waste liquid adjusting device 67 to supply the silica concentration adjusting agent, the pH adjusting agent, or the ion concentration adjusting agent to the fluid flowing through the fifth chemical agent recovery line L14e between the secondary-impurity recovery tank 78 and the third adjusted-liquid tank 79 based on a measurement result of the seventh analyzer 68g.

With this configuration, the controller 40 can cause the waste liquid adjusting device 67 to supply an appropriate amount of the silica concentration adjusting agent, pH adjusting agent, or ion concentration adjusting agent according to the silica concentration, the pH, or the ion concentration of the secondary-impurity recovery tank 78. Therefore, the geothermal power generation system 1 can return the secondary impurity to the re-injection well 4 after sufficiently adjusting it.

The geothermal power generation system 1 includes the eighth analyzer 68h, the residue recovery tank 75, and the second three-way valve V15. The controller 40 controls the second three-way valve V15 such that the first adjusted-liquid tank 74 communicates with the re-injection well 4 when the concentration of the adjusted scale-containing substance measured by the eighth analyzer 68h is within a specified range.

With this configuration, the geothermal power generation system 1 can return the adjusted scale-containing substance to the re-injection well 4 only when the concentration of the adjusted scale-containing substance is within the specified range, and can store the adjusted scale-containing substance in the residue recovery tank 75 when the concentration of the adjusted scale-containing substance is outside the specified range.

The geothermal power generation system 1 includes the ninth analyzer 68i and the third three-way valve V16. The controller 40 controls the third three-way valve V16 such that the second adjusted-liquid tank 77 communicates with the re-injection well 4 when the concentration of the adjusted scale-containing substance measured by the ninth analyzer 68i is within a specified range.

With this configuration, the geothermal power generation system 1 can return the adjusted primary impurity to the re-injection well 4 only when the concentration of the adjusted primary impurity is within a specified range, and can store the adjusted primary impurity in the residue recovery tank 75 when the concentration of the adjusted primary impurity is outside the specified range.

The geothermal power generation system 1 includes the tenth analyzer 68j and the fourth three-way valve V17, and the controller 40 controls the fourth three-way valve V17 such that the third adjusted-liquid tank 79 communicates with the re-injection well 4 when the concentration of the adjusted scale-containing substance measured by the tenth analyzer 68j is within a specified range.

With this configuration, the geothermal power generation system 1 can return the adjusted secondary impurity to the re-injection well 4 only when the concentration of the adjusted secondary impurity is within the specified range, and can store the adjusted secondary impurity in the residue recovery tank 75 when the concentration of the adjusted secondary impurity is outside the specified range.

The geothermal power generation system 1 includes the second valve V2, the third pipe L3, the branching section 6 which can branch the flow path of the third pipe L3 into the analysis line L11 and the chemical agent supply line L12, and the chemical agent adding device 50.

With this configuration, the geothermal power generation system 1 can introduce the geothermal brine flowing through the second pipe L2 into the analyzer 30 through the analysis line L11 in a closed state without opening or decomposing the geothermal power generation system 1. In addition, the first valve V1 and the second valve V2 are closed, and the optimum chemical agent corresponding to the components of the scale is added to the geothermal brine flowing through the third pipe L3, and the chemical agent is distributed from the chemical agent supply port 5 to the first pipe L1 and the second pipe L2 through the chemical agent supply line L12, thereby cleaning the first pipe L1 and the second pipe L2.

The geothermal power generation system 1 includes the third valve V3. Thus, by closing the third valve V3, the geothermal brine or the chemical agent flowing through the third pipe L3 can be distributed only to the analysis line L11, such that the scale components contained in the geothermal brine can be analyzed by the analyzer 30 before the chemical agent is distributed to the chemical agent supply line L12.

The geothermal power generation system 1 includes the fourth pipe L4. Thereby, the geothermal brine discharged from the first outlet 34 of the analyzer 30 can be supplied to the first pipe L1 from the chemical agent supply port 5 via the chemical agent supply line L12 and be utilized for binary power generation.

The geothermal power generation system 1 includes the flowmeter 9, and the analyzer 30 includes the separation vessel 31, the gas analyzer 32, and the liquid analyzer 33. Thus, the geothermal power generation system 1 can adjust the flow rate of the geothermal brine flowing into the analysis line L11 to be smaller with respect to the flow rate of the geothermal brine flowing into the chemical agent supply line L12, separate the geothermal brine into solid substances, liquid, and gas in the separation vessel 31, and analyze the separated gas by the gas analyzer 32 and the separated liquid by the liquid analyzer 33. Thus, the analyzer 30 can determine the optimum chemical agent according to the components of the scale contained in the geothermal brine.

In the geothermal power generation system 1, the controller 40 determines at least one chemical agent from a plurality of chemical agent candidates, based on the gas analysis results of the analyzer 30, and controls the supply of the chemical agent. With this configuration, the chemical agent is introduced into the separation vessel 31 of the analyzer 30, the scale deposited inside the separation vessel 31 is reacted with the chemical agent, and the components contained in the scale can be determined based on the gas analysis results of the generated gas. Therefore, the analyzer 30 can determine the optimum chemical agent according to the components of the scale contained in the geothermal brine.

In the geothermal power generation system 1, the gas analyzer 32 measures the concentration of oxygen and the concentration of carbon dioxide. Thus, the controller 40 can determine whether or not the components contained in the scale are ooze, calcium carbonate, amorphous silica, or iron rust based on the concentration of oxygen and the concentration of carbon dioxide after introducing the hydrogen peroxide agent or the acidic agent into the separation vessel 31 of the analyzer 30 and reacting the hydrogen peroxide agent or the acidic agent with the scale deposited inside the separation vessel 31. Therefore, the controller 40 can determine the optimum chemical agent according to the components of the scale contained in the geothermal brine.

In the geothermal power generation system 1, the liquid analyzer 33 measures the pH level, the dielectric constant, and the dissolved ion concentration. Thus, the controller 40 can remove the scale by causing the liquid analyzer 33 to detect the pH level of the fluid introduced into the analyzer 30 and, based on the detected pH level, controlling the supply of the acidic agent or the basic agent to the fluid such that the pH level becomes the pH level required to dissolve the scale. When the chelating agent is used as the chemical agent, the pH level of the fluid can be adjusted by causing the liquid analyzer 33 to detect the pH level of the fluid and, based on the detected pH level, controlling the supply of the acidic agent or the basic agent to the fluid such that the pH level is appropriate. In addition, the controller 40 can determine the cleaning state based on the detected dielectric constant or the dissolved ion concentration by causing the liquid analyzer 33 to detect the dielectric constant or a dissolved ion concentration of the fluid introduced into the analyzer 30. Thus, the geothermal power generation system 1 can sufficiently remove the scale regardless of the scale components.

In the geothermal power generation system 1, the separation vessel 31 generates a swirling flow inside the separation vessel 31 to separate solid substances, liquid, and gas contained in the geothermal brine. Thus, the geothermal power generation system 1 can efficiently analyze the scale components contained in geothermal brine by the analyzer 30.

In the geothermal power generation system 1, the separation vessel 31 has a cylindrical shape, includes the housing 311, the geothermal brine inlet 312, the geothermal brine outlet 313, the first chamber R1, the second chamber R2, and the third chamber R3; the first chamber R1, the second chamber R2, and the third chamber R3 communicate at a central portion thereof; the first chamber R1 includes the gas outlet 314, the second chamber R2 includes the first solid-substance outlet 315, the third chamber R3 includes the second solid-substance outlet 319 and the liquid outlet 316; and the geothermal brine inlet 312 is arranged on the lower side, in a vertical direction, relative to the geothermal brine outlet 313.

With the above configuration, the separation vessel 31 can efficiently separate solid substances, liquid, and gas contained in the geothermal brine by generating a swirling flow inside the separation vessel 31. Therefore, the geothermal power generation system 1 can efficiently analyze the scale components contained in the geothermal brine by the analyzer 30.

In the geothermal power generation system 1, the geothermal power generation system 1 includes the recovery tank 10. Thus, the geothermal power generation system 1 can remove solid substances unnecessary for the analysis by the analyzer 30.

In the geothermal power generation system 1, the chemical agent adding device 50 includes the plurality of chemical agent tanks 51a, 51b, and 51c, the chemical agent injection pump 52, the water tank 53, and the liquid feed pump 54. Therefore, the geothermal power generation system 1 can supply the optimum chemical agent according to the components of the scale from the chemical agent supply port 5 among the plurality of chemical agent candidates. Therefore, the geothermal power generation system 1 can remove the scale regardless of the components of the scale.

In the geothermal power generation system 1, the plurality of chemical agent candidates include two or more chemical agents selected from a group including acidic agents, basic agents, chelating agents, hydrogen peroxide agents, dispersants, and catalase agents. Thus, the geothermal power generation system 1 can supply the optimum chemical agent for each of ooze, calcium carbonate, amorphous silica, and iron rust contained in the scale from the chemical agent supply port 5.

In the geothermal power generation system 1, the fourth valve V4 is included; the controller 40 causes the analysis line L11 and the analyzer 30 to take-in the geothermal brine with the fourth valve V4 closed, before determining a chemical agent, and to collect the separated solid substances in the separation vessel 31, closes the first valve V1, the second valve V2, and the third valve V3, and causes the chemical agent adding device 50 to supply the acidic agent or the hydrogen peroxide agent to the analysis line L11; and the analyzer 30 analyzes the gas generated by a chemical reaction between the solid substances and the acidic agent or the hydrogen peroxide agent.

In the geothermal power generation system 1, the controller 40 can determine the cleaning state based on the analysis result of the components contained in the fluid analyzed by the analyzer 30 after the fluid in which the chemical agent has been added to the geothermal brine flowing through the third pipe L3 is circulated to the chemical agent supply line L12, the first pipe L1, the second pipe L2, and the third pipe L3 by the chemical agent adding device 50. Therefore, the geothermal power generation system 1 can sufficiently remove the scale regardless of the components of the scale.

In the geothermal power generation system 1, the water stored in the water tank is one kind selected from a group including tap water, river water, and distilled water. Thus, even when the geothermal brine in the first pipe L1 and the second pipe L2 is drained before cleaning, the geothermal power generation system 1 can introduce the water stored in the water tank into the third pipe L3 together with the chemical agent, and supply it to the first pipe L1 from the chemical agent supply port 5 through the chemical agent supply line L12.

### Second Embodiment

A geothermal power generation system 100 according to a second embodiment will be described in the following. The geothermal power generation system 100 according to the second embodiment stops an ordinary operation (power generation) and cleans a re-injection line L100. First, a configuration for cleaning the geothermal power generation system 100 will be described.

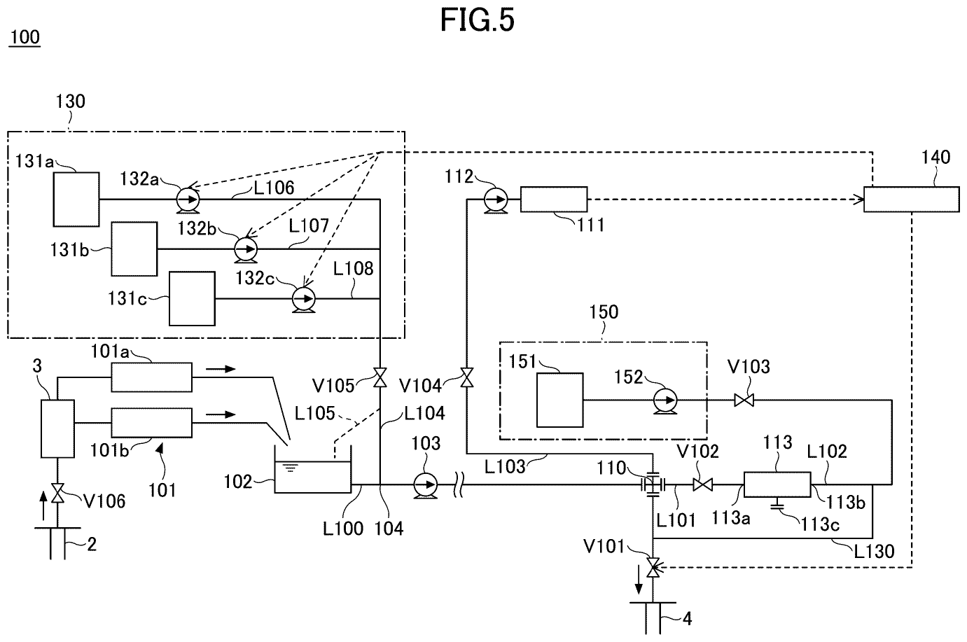

FIG. 5 is a schematic configurational diagram of the geothermal power generation system according to the second embodiment. As illustrated in FIG. 5, the geothermal power generation system 100 includes the gas-liquid separator 3, a power generator 101, a retention tank 102, the re-injection line L100, a re-injection pump 103, a chemical agent injection port 104, a first chemical agent adding device 130, and a controller 140. In FIG. 5, arrows indicate directions in which a fluid flows.

In the geothermal power generation system 100, a geothermal fluid collected from a production well 2 is sent to the gas-liquid separator 3. The gas-liquid separator 3 separates the geothermal brine and the geothermal steam from the geothermal fluid ejected from the production well 2. The geothermal brine and the geothermal steam separated by the gas-liquid separator 3 are sent to the power generator 101 via piping, and the power generator 101 uses the geothermal brine or the geothermal steam separated by the gas-liquid separator 3 as a heat source to generate power. The geothermal brine to which the heat is recovered by the power generator 101 is introduced into the retention tank 102 via the piping.

In the example as illustrated in FIG. 5, the geothermal steam separated by the gas-liquid separator 3 is sent to a flash power generator 101a, and the flash power generator 101a uses the geothermal steam separated by the gas-liquid separator 3 as the heat source to generate power. The geothermal brine separated by the gas-liquid separator 3 is sent to a binary power generator 101b, and the binary power generator 101b uses the geothermal brine separated by the gas-liquid separator 3 as the heat source to generate power.

The power generator 101 is not particularly limited, and may include the flash power generator 101a and the binary power generator 101b, and may include either the flash power generator 101a or the binary power generator 101b.

The flash power generator 101a includes a turbine configured to rotate upon being supplied with the geothermal steam separated by the gas-liquid separator 3, a power generator connected to the turbine, a condenser configured to condense the geothermal steam discharged from the turbine, a cooling tower configured to cool the condensate condensed by the condenser, and the like. The binary power generator 101b includes a medium evaporator configured to evaporate a low-boiling-point heat medium by exchanging heat, the turbine that rotates upon being supplied with a vaporized heat medium, the power generator, the medium condenser, and the like.

The retention tank 102 stores the geothermal brine from which heat has been recovered by the power generator 101. Then, a polymerization reaction of silica in the geothermal brine proceeds, and the geothermal brine is retained until the silica-based insoluble components are sufficiently aggregated and precipitated.

The re-injection line L100 is a line connecting the outlet portion of the retention tank 102 and a re-injection well 4.

The re-injection pump 103 is provided in the re-injection line L100, and returns the geothermal brine discharged from the retention tank 102 to the re-injection well 4. The geothermal brine discharged from the retention tank 102 is returned to the re-injection well 4 via the re-injection line L100 by the re-injection pump 103.

The chemical agent injection port 104 is provided in the re-injection line L100 between the retention tank 102 and the re-injection pump 103.

The first chemical agent adding device 130 is a device configured to inject a chemical agent into the chemical agent injection port, and may include a plurality of chemical agent tanks 131a, 131b, and 131c that respectively contain a chemical agent, and a plurality of chemical agent injection pumps 132a, 132b, and 132c, each of which is connected to the corresponding one of the plurality of chemical agent tanks 131a, 131b, and 131c, each configured to discharge the chemical agent toward the chemical agent injection port 104. The number of the chemical agent tanks 131a, 131b, and 131c is three in the example as illustrated in FIG. 5, but is not limited thereto, and may be selected according to the number of the chemical agents to be used, and may be four or more. The number of the chemical agent injection pumps 132a, 132b, and 132c may be selected according to the number of the chemical agent tanks 131a, 131b, and 131c.

Each of the plurality of chemical agent tanks 131a, 131b, and 131c may contain one chemical agent selected from a group including a tracer reagent, a detergent, and a corrosive agent having a corrosive effect on the metal included in the re-injection line L100. For example, the chemical agent tank 131a contains a tracer reagent, the chemical agent tank 131b contains a detergent, and the chemical agent tank 131c contains a corrosive agent. Hereinafter, the chemical agent injection pump connected to the chemical agent tank 131a containing a tracer reagent may be referred to as a tracer reagent injection pump 132a, the chemical agent injection pump connected to the chemical agent tank 131b containing a detergent may be referred to as a detergent injection pump 132b, and the chemical agent injection pump connected to the chemical agent tank 131c containing a corrosive agent may be referred to as a corrosive agent injection pump 132c.

The tracer reagent is used to confirm that the detergent has arrived at the downstream side of the re-injection line L100. Examples of the tracer reagent include, for example, halogens such as iodine and bromine; radioactive isotopes such as iodine 131, bromine 82, and tritium; aromatic sulfonate such as sodium benzoate, sodium toluenesulfonate, sodium xylene sulfonate, sodium benzenesulfonate, 1-naphthalenesulfonic acid, 1,5-naphthalenedisulfonic acid; fluorescent dyes such as fluorescein sodium, rhodamine WT, 2,6,8-naphthylamine disulfonic acid (amino G acid); metal indicator; and the like. Among these, the tracer reagent is preferably the aromatic sulfonate.

The detergent is used to remove and clean the scale adhered inside the piping of the re-injection line L100. The detergent may include, for example, one or more chemical agents selected from a group including an acidic agent, a basic agent, a chelating agent, a hydrogen peroxide agent, a dispersant, and a catalase agent.

The acidic agent can be used to dissolve calcium-based scales. Examples of the acidic agent include sulfuric acid, hydrochloric acid, acetic acid, citric acid, and the like.

The basic agents can be used to dissolve silica-based scales (amorphous silica). Examples of the basic agents include sodium hydroxide, potassium hydroxide, ammonium salts, and the like.

The chelating agents can be used to perform masking of dissolved metals in the geothermal brine and suppress waste of other detergents before using other detergents under pH control. Examples of the chelating agents include ethylenediaminetetraacetic acid (EDTA), nitrilotriacetic acid (NTA), hydroxyethylenediaminetriacetic acid (HEDTA), diethylenetriaminepentaacetic acid (DTPA), trimethanolamine, sodium gluconate, and the like.

The hydrogen peroxide agent can be used to dissolve ooze. Examples of the hydrogen peroxide agent include a hydrogen peroxide solution.

The dispersant can be used to disperse and peel off the scales adhered to the inner wall of the piping. Examples of the dispersant include sodium polyacrylate and various surfactants.

The catalase agent can be used to decompose the hydrogen peroxide agent remaining in the geothermal brine after using the hydrogen peroxide agent.

The corrosive agent is a chemical agent that flows through the re-injection line L100 after cleaning, elutes the metal contained in the piping of the re-injection line L100, and is used to determine a cleaning state by the concentration of eluted metal ions. The corrosive agent may be, for example, any acid selected from a group including a sulfuric acid, a hydrochloric acid, an acetic acid, and a citric acid.

The geothermal power generation system 100 may include a fourth pipe L104 that is connected to the chemical agent injection port 104 of the re-injection line L100, and a fifth valve V105 that is provided in the fourth pipe L104 and configured to open and close a flow path of the fourth pipe L104. The first chemical agent adding device 130 may include a sixth pipe L106 that branches from the fourth pipe L104 and is connected to an outlet port of the chemical agent injection pump 132a, a seventh pipe L107 that branches from the fourth pipe L104 and is connected to an outlet port of the chemical agent injection pump 132b, and an eighth pipe L108 that branches from the fourth pipe L104 and is connected to an outlet port of the chemical agent injection pump 132c.

The geothermal power generation system 100 may include a temporary fifth pipe L105 that branches from the fourth pipe L104 and extends to the inlet of the retention tank 102, depending on the distance between the retention tank 102 and the re-injection pump 103. In this case, the chemical supplied from the first chemical agent adding device 130 is supplied to the re-injection line L100 from the outlet portion of the retention tank 102 together with the geothermal brine in the retention tank 102.

The geothermal power generation system 100 includes a branching section 110 that is provided in the re-injection line L100 on the downstream side relative to the re-injection pump 103 as well as above the re-injection well 4 in the vertical direction and configured to branch the flow of the geothermal brine, a first liquid analyzer 111 that is connected vertically upward from the branching section 110, and a scale-piece collector 113 that is connected in a horizontal direction from the branching section 110. The branching section 110 branches the flow of the geothermal brine into four directions, and may be, for example, a four-way valve. The geothermal power generation system 100 may include a first valve (re-injection valve) V101 provided in the re-injection line L100 between the branching section 110 and the re-injection well 4 and configured to open and close a flow path between the branching section 110 and the re-injection well 4.

The first liquid analyzer 111 is connected to a third pipe L103 branched from the branching section 110. The first liquid analyzer 111 is configured to analyze and detect components contained in the fluid. The first liquid analyzer 111 detects at least a tracer reagent. The first liquid analyzer 111 also measures the pH, a dielectric constant, or a dissolved ion concentration. The first liquid analyzer 111 may be, for example, a high-performance liquid chromatograph.

The geothermal power generation system 100 may include a liquid feed pump 112 which is provided in the third pipe L103 and is configured to discharge the fluid flowing through the re-injection line L100 toward an inlet of the first liquid analyzer 111, and a fourth valve V104 which is provided in the third pipe L103 on the upstream side relative to the liquid feed pump 112 and is configured to open and close a flow path of the third pipe L103.

The scale-piece collector 113 includes a residue input port 113a, a dissolving agent injection port 113b, and a residue discharge port 113c, and is configured to collect scale pieces flowing through the re-injection line L100 after cleaning of the re-injection line L100 is completed. The geothermal power generation system 100 may include a first pipe L101 connecting the branching section 110 and the residue input port 113a, and a second valve V102 provided in the first pipe L101 and configured to open and close a flow path of the first pipe L101.

The geothermal power generation system 100 may include a dissolving agent adding device 150 configured to inject a dissolving agent into the dissolving agent injection port 113b of the scale-piece collector 113. The dissolving agent adding device 150 may include a dissolving agent tank 151 containing the dissolving agent, and a dissolving agent injection pump 152 connected to the dissolving agent tank 151 and configured to discharge the dissolving agent toward the dissolving agent injection port 113b. The dissolving agent is a chemical agent for dissolving the scale collected in the scale-piece collector 113, and can be any chemical agent selected from a group including, for example, a basic agent, a fluoride agent, and an acidic agent.

As the basic agent and the acidic agent, the same chemical agent as the above-described detergent can be used. Examples of the fluoride agent include hydrofluoric acid, hexafluorophosphate, ammonium fluoride, and the like.

The geothermal power generation system 100 may include a second pipe L102 connecting the dissolving agent injection port 113b and an outlet port of the dissolving agent injection pump 152, and a third valve V103 provided in the second pipe L102 and configured to open and close a flow path of the second pipe L102.

Based on an analysis result of the first liquid analyzer 111, the controller 140 switches between an injection operation and injection stoppage of the chemical agent performed by the first chemical agent adding device 130 and an injection operation and injection stoppage of the dissolving agent performed by the dissolving agent adding device 150. Specifically, based on the analysis result of the first liquid analyzer 111, the controller 140 controls the plurality of chemical agent injection pumps 132a, 132b, and 132c, the dissolving agent injection pump 152, and the first valve V101.

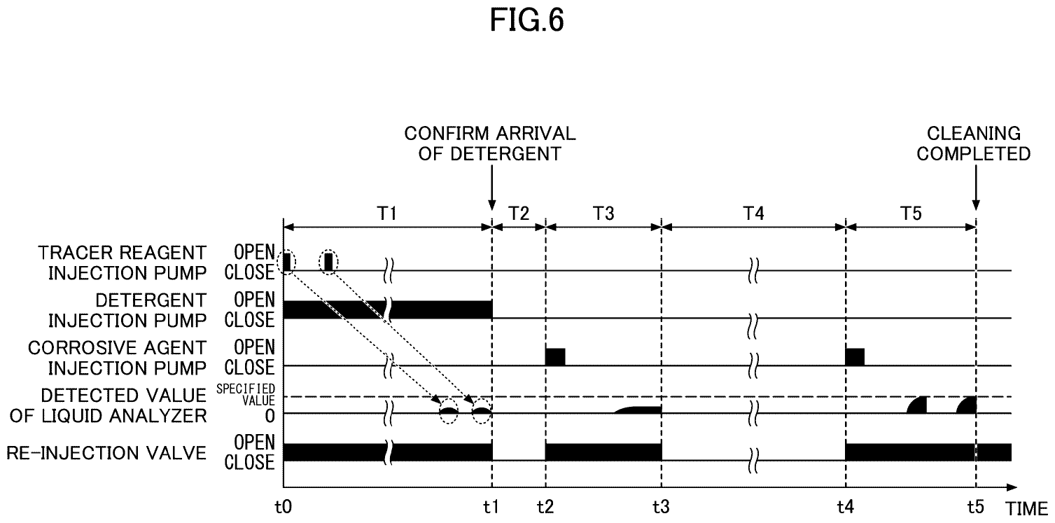

FIG. 6 is a time chart illustrating the operation of cleaning in the geothermal power generation system according to the second embodiment. The controller 140 may execute the cleaning operation by supplying a detergent with the first chemical agent adding device 130 and supplying a tracer reagent for two or more times at an interval of 5 minutes or more, and after the first liquid analyzer 111 detects the tracer reagent as many times as the number of times the tracer reagent has been supplied, stopping the supply of the detergent, and closing the first valve (re-injection valve) V101.

As illustrated in FIG. 6, at time t0, with the first valve (re-injection valve) V101 open, the controller 140 sends a command to the tracer reagent injection pump 132a to discharge the tracer reagent at two or more supply times at the interval of 5 minutes or more, and sends a command to the detergent injection pump 132b to continuously discharge the detergent. After receiving a signal from the first liquid analyzer 111 indicating that the tracer reagent has been detected the same number of times as the number of times the tracer reagent has been supplied, the controller 140 sends a command, at time t1, to stop the discharge of the detergent to the detergent injection pump 132b and at the same time sends a command to the first valve V101 to close the first valve V101. By receiving the signal indicating that the tracer reagent has been detected the same number of times as the number of times the tracer reagent has been supplied, the controller 140 can confirm that the detergent has arrived at the downstream side of the re-injection line L100. A period T1 is the length of time required for the detergent to arrive at the downstream side of the re-injection line L100.

After 2 to 3 hours have elapsed from the time when the first valve (re-injection valve) V101 is closed, the controller 140 opens the first valve V101 and, with the first valve V101 open, causes a corrosive agent to be supplied by the first chemical agent adding device 130, and determines a cleaning state based on the concentration of metal ions detected by the first liquid analyzer 111.

At time t2, after 2 to 3 hours (period T2) have elapsed from the time t1 when the detergent injection pump 132b is stopped and the first valve (re-injection valve) V101 is closed, the controller 140 sends a command to the corrosive agent injection pump 132c to discharge a corrosive agent and at the same time sends a command to the first valve V101 to open the first valve V101. The period T2 is the length of time required for sufficiently bringing the detergent into contact with the inner wall of the piping of the re-injection line L100. After receiving a measured value of the concentration of metal ions from the first liquid analyzer 111, the controller 140 determines the cleaning state at time t3 after a period T3 has elapsed. The period T3 is the length of time required for confirming the cleaning state.

As the cleaning proceeds, the inner wall of the pipe is exposed and the metal of the pipe dissolves into the fluid, and thus the concentration of metal ions contained in the fluid increases. The concentration of metal ions detected by the first liquid analyzer 111 may be the concentration of iron ions. For example, the controller 140 may determine that the cleaning is complete when the concentration of iron ions reaches 100 ppm. The analysis result of the analysis by the first liquid analyzer 111 may be a dielectric constant.

When the concentration of metal ions detected by the first liquid analyzer 111 is less than a specified value, the controller 140 determines that the cleaning is not complete, executes the cleaning operation of the periods T1 to T3 again, and repeats the cleaning operation of the periods T1 to T3 until the concentration of metal ions detected by the first liquid analyzer 111 reaches the specified value. A period T4 is the length of time required for repeating the cleaning operation of the periods T1 to T3. Since the time chart illustrating the cleaning operation of the period T4 is the same as that for the periods T1 to T3, its description is omitted from FIG. 6.

When the concentration of metal ions detected by the first liquid analyzer 111 reaches the specified value, the controller 140 determines that the cleaning operation is completed at time t5, terminates the cleaning operation, and returns to the ordinary operation. A period T5, which is a period from time t4 to the time t5, is a final period including the period T3 for confirming the cleaning state among a plurality of confirmation times.

When the concentration of the metal ions detected by the first liquid analyzer 111 reaches the specified value and it is determined that the cleaning is completed, the controller 140 causes the geothermal brine to flow into the residue input port 113a, causes the scale-piece collector 113 to collect the scale pieces, and then causes the dissolving agent adding device 150 to inject the dissolving agent into the dissolving agent injection port 113b, and closes the second valve V102 and the third valve V103. Specifically, when the concentration of the metal ions detected by the first liquid analyzer 111 reaches the specified value and it is determined that the cleaning is completed, the controller 140 preferably performs control to open the second valve V102 and causes the geothermal brine to flow into the residue input port 113a for at least 1 week. As a result, the geothermal power generation system 100 can sufficiently collect the scale pieces flowing through the re-injection line L100 after the cleaning, in the scale-piece collector 113. Next, the controller 140 causes the dissolving agent adding device 150 to inject the dissolving agent into the dissolving agent injection port 113b, and when the dissolving agent is a basic agent, causes the second valve V102 and the third valve V103 to close when the pH of the fluid in the scale-piece collector 113 reaches a specified value. The pH of the fluid in the scale-piece collector 113 can be detected by, for example, a pH meter (not illustrated) provided in the scale-piece collector 113, and the controller 140 receives a measured pH value from the pH meter.

Since the temperature of the scale-piece collector 113 is maintained high by the sensible heat of the re-injection well 4, the advantageous effect of the dissolving agent in the scale-piece collector 113 can be enhanced and the dissolution of the scale pieces can be promoted. From the viewpoint of promoting the dissolution of the scale pieces, it is preferable to arrange the scale-piece collector 113 to maintain the temperature in the scale-piece collector 113 at 80° C. or higher.

The controller 140 controls the flow of the fluid containing the dissolved scale pieces in the scale-piece collector 113 to the re-injection well 4 via the first pipe L101 by closing the second valve V102 and the third valve V103, leaving the second valve V102 and the third valve V103 closed for 48 hours or more, and then opening the second valve V102. Specifically, the controller 140 controls application of pressure inside the scale-piece collector 113 by a pressurizing device (not illustrated) to push back the geothermal brine that flows in from the residue input port 113a through the opened second valve V102, and to send the fluid containing the dissolved scale pieces in the scale-piece collector 113 to the re-injection well 4 through the first pipe L101.

The controller 140 controls the discharge of the scale pieces, rock fragments, iron rust, and the like remaining in the scale-piece collector 113 to the outside through the residue discharge port 113c.

The controller 140 may also control the re-injection pump 103, the liquid feed pump 112, the fourth valve V104, the fifth valve V105, and a sixth valve V106.

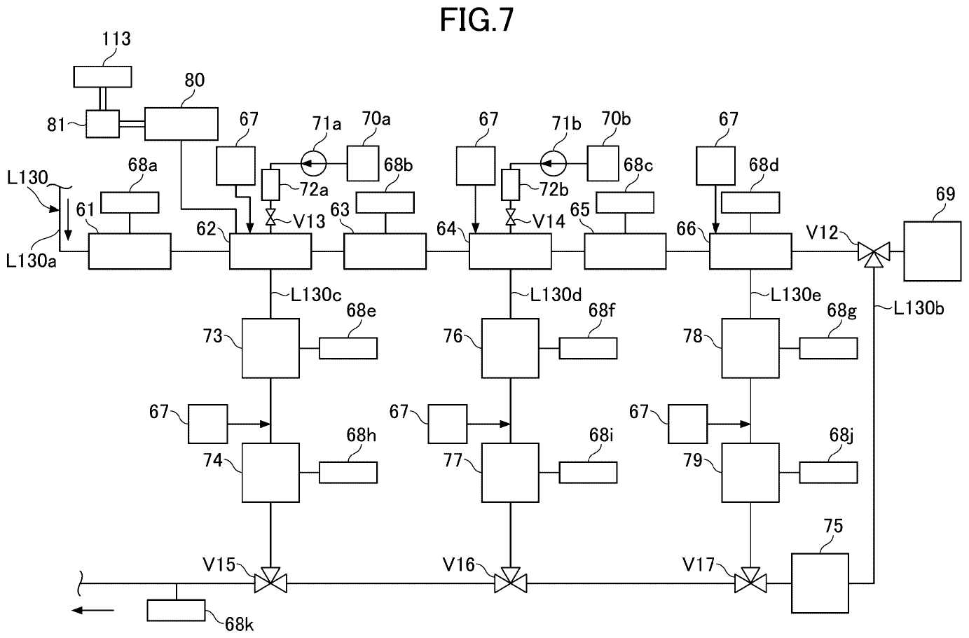

Next, a configuration for recovering a chemical agent in the geothermal power generation system 100 will be described. FIG. 7 is a schematic configurational diagram of a chemical agent recovery line L130 in the geothermal power generation system 100 according to the second embodiment. As illustrated in FIG. 7, the geothermal power generation system 100 includes the chemical agent recovery line L130 branched from a pipe connecting the dissolving agent injection port 113b and the dissolving agent adding device 150 and connected to a pipe connecting the branching section 110 and the re-injection well 4. Furthermore, as illustrated in FIG. 7, the geothermal power generation system 100 includes the waste liquid recovery section 61, the scale separator 62, the first chemical agent recovery section 63, the impurity separator 64, the second chemical agent recovery section 65, the chemical agent purifier 66, and the recycled-chemical-agent tank 69, which are provided in the chemical agent recovery line L130 in order from the upstream side, and the waste liquid adjusting device 67. The waste liquid adjusting device 67 is connected to each of the scale separator 62, the impurity separator 64, and the chemical agent purifier 66.

The chemical agent recovery line L130 may include a first chemical agent recovery line L130a connecting the waste liquid recovery section 61, the scale separator 62, the first chemical agent recovery section 63, the impurity separator 64, the second chemical agent recovery section 65, the chemical agent purifier 66, and the recycled-chemical-agent tank 69, and a second chemical agent recovery line L130b branching from the first chemical agent recovery line L130a between the chemical agent purifier 66 and the recycled-chemical-agent tank 69. The chemical agent recovery line L130 may include a third chemical agent recovery line L130c branched from the second chemical agent recovery line L130b and connected to the scale separator 62, a fourth chemical agent recovery line L130d branched from the second chemical agent recovery line L130b and connected to the impurity separator 64, and a fifth chemical agent recovery line L130e branched from the second chemical agent recovery line L130b and connected to the chemical agent purifier 66.

The waste liquid that has passed through the scale-piece collector 113 flows into the chemical agent recovery line L130, is purified as it passes through the waste liquid recovery section 61, the scale separator 62, the first chemical agent recovery section 63, the impurity separator 64, the second chemical agent recovery section 65, and the chemical agent purifier 66, and the recycled chemical agent purified from the waste liquid is stored in the recycled-chemical-agent tank 69. The impurities and the like generated in the process of purifying the waste liquid into the recycled chemical agent are adjusted and returned to the re-injection well 4 from the second chemical agent recovery line L130b through the third chemical agent recovery line L130c, the fourth chemical agent recovery line L130d, and the fifth chemical agent recovery line L130e.

The geothermal power generation system 100 may include a heat exchanger 80 configured to exchange heat between the waste liquid and a refrigerant in the waste liquid recovery section 61, and a heat pump 81 configured to supply the heat that has been recovered by the heat exchanger 80 to the scale-piece collector 113. The configuration for recovering the chemical agent in the geothermal power generation system 100 differs from the configuration for recovering the chemical agent in the geothermal power generation system 1 of the first embodiment in that the configuration may include the heat exchanger 80 and the heat pump 81. The configuration for recovering the chemical agent in the geothermal power generation system 100 other than the heat exchanger 80 and the heat pump 81 is the same as the configuration for recovering the chemical agent in the geothermal power generation system 1 of the first embodiment, and thus description thereof will be omitted.

The heat exchanger 80 may be connected to the waste liquid recovery section 61 or to the impurity separator 64. The heat exchanger 80 may be connected to the chemical agent recovery line L130 between the waste liquid recovery section 61 and the scale separator 62, and the heat exchanger 80 may be connected to the chemical agent recovery line L130 between the scale separator 62 and the first chemical agent recovery section 63, the chemical agent recovery line L130 between the first chemical agent recovery section 63 and the impurity separator 64, or the chemical agent recovery line L130 between the impurity separator 64 and the second chemical agent recovery section 65.

The geothermal power generation system 100 includes the gas-liquid separator 3, the power generator 101, the retention tank 102, the re-injection line L100, the re-injection pump 103, the chemical agent injection port 104 provided in the re-injection line L100 between the retention tank 102 and the re-injection pump 103, and a first chemical agent adding device 130. Furthermore, the geothermal power generation system 100 is provided with the branching section 110, the first liquid analyzer 111, the scale-piece collector 113 including the residue input port 113a, the dissolving agent injection port 113b, and the residue discharge port 113c, the dissolving agent adding device 150, the controller 140 configured to switch between an injection operation and injection stoppage of the chemical agent performed by the first chemical agent adding device 130 and to switch between an injection operation and injection stoppage of the dissolving agent performed by the dissolving agent adding device 150 based on an analysis result of the first liquid analyzer 111, the chemical agent recovery line L130, the waste liquid recovery section 61, the scale separator 62, the first chemical agent recovery section 63, the impurity separator 64, the second chemical agent recovery section 65, the chemical agent purifier 66, the recycled chemical agent tank 69, and the waste liquid adjusting device 67, wherein the waste liquid adjusting device 67 includes the scale separator 62, an impurity separator 64, and the chemical agent purifier 66.

With this configuration, the controller 140 confirms arrival of the chemical agent based on an analysis result of the first liquid analyzer 111 provided on the downstream side of the re-injection line L100, and switches between an injection operation and injection stoppage of the chemical agent by the first chemical agent adding device 130. Therefore, the geothermal power generation system 100 can clean the re-injection line L100 of the geothermal power generation system 100 by spreading the chemical agent from the upstream side to the downstream side of the re-injection line L100 in a state in which the geothermal power generation system 100 is closed, that is, in a state not opened to an external environment or decomposed. Moreover, the geothermal power generation system 100 collects scale pieces by the scale-piece collector 113 even when there are scale pieces flowing in the re-injection line L100 after cleaning of the re-injection line L100, and the controller 140 switches between an injection operation and the injection stoppage of the dissolving agent by the dissolving agent adding device 150. Therefore, the geothermal power generation system 100 can dissolve and remove the scale pieces flowing through the re-injection line L100 after cleaning of the geothermal power generation system 100 is performed, in a state in which the geothermal power generation system 100 is closed, that is, in a state not opened to an external environment or decomposed. Thus, the geothermal power generation system 100 can sufficiently remove the scale of the re-injection line L100.

Furthermore, the waste liquid after cleaning the re-injection line L100 is adjusted by the waste liquid adjusting device 67 as the waste liquid flows through the waste liquid recovery section 61, the scale separator 62, the first chemical agent recovery section 63, the impurity separator 64, the second chemical agent recovery section 65, and the chemical agent purifier 66, such that the scale-containing substance and impurities are sequentially separated and removed, and thus the waste liquid is purified. Therefore, the geothermal power generation system 1 can obtain a purified recycled chemical agent from the waste liquid, and a recycled chemical agent is stored in the recycled-chemical-agent tank 69. Thus, the geothermal power generation system 100 can sufficiently remove the scale and recover the chemical agent used for cleaning.

The geothermal power generation system 100 includes the heat exchanger 80 and the heat pump 81 configured to supply the heat that has been recovered by the heat exchanger 80 to the scale-piece collector 113. According to this configuration, when the silica scale is precipitated by lowering the temperature of the fluid in the scale separator 62 and the silica scale is separated, the waste heat generated by lowering the temperature of the fluid can be utilized as heat for accelerating dissolution of the scale pieces in the scale-piece collector 113.

Specifically, the geothermal power generation system 100 includes the first valve V101, the first chemical agent adding device 130 includes the plurality of chemical agent tanks 131a, 131b, and 131c and the plurality of chemical agent injection pumps 132a, 132b, and 132c, and the dissolving agent adding device 150 includes the dissolving agent tank 151 and the dissolving agent injection pump 152. The controller 140 controls the plurality of chemical agent injection pumps 132a, 132b, and 132c, the dissolving agent injection pump 152, and the first valve V101 based on an analysis result of the first liquid analyzer 111.

According to this configuration, the controller 140 selects the chemical agent corresponding to the purpose from the plurality of agents based on the analysis result of the first liquid analyzer 111 and controls the chemical agent injection pump which discharges the chemical agent, such that the geothermal power generation system 100 can supply the chemical agent corresponding to the purpose to the re-injection line L100. Then, by closing the first valve V101 after the controller 140 distributes the chemical agent to the entire re-injection line L100, the geothermal power generation system 100 can sufficiently cause the chemical agent to contact the inner wall of the piping of the re-injection line L100 to enhance the cleaning effect. Furthermore, the controller 140 controls the dissolving agent injection pump 152 based on the analysis result of the first liquid analyzer 111, such that the geothermal power generation system 100 can sufficiently dissolve and remove the scale pieces flowing through the re-injection line L100 after cleaning the re-injection line L100. Thus, the geothermal power generation system 100 can more fully remove the scale of the re-injection line L100.

In the geothermal power generation system 100, the plurality of chemical agent tanks 131a, 131b, and 131c respectively contain a tracer reagent, a detergent, or a corrosive agent having a corrosive effect on the metal of the re-injection line L100. Thus, by supplying the tracer reagent to the re-injection line L100 at the same time as the detergent, the geothermal power generation system 100 can confirm the arrival of the detergent by the first liquid analyzer 111, and can clean the re-injection line L100 by spreading the detergent all the way from the upstream side to the downstream side of the re-injection line L100. Moreover, by supplying the corrosive agent to the re-injection line L100, the geothermal power generation system 100 can elute the metal included in the piping of the re-injection line L100, and can determine a cleaning state by the concentration of the eluted metal ions. Therefore, the geothermal power generation system 100 can more fully remove the scale of the re-injection line L100.

In the geothermal power generation system 100, the tracer reagent is preferably an aromatic sulfonate. By supplying the aromatic sulfonate as the tracer reagent to the re-injection line L100 at the same time as the detergent, the geothermal power generation system 100 can readily detect the tracer reagent by the first liquid analyzer 111, and can readily confirm the arrival of the detergent.

In the geothermal power generation system 100, the detergent includes one or more chemical agents selected from a group including acidic agents, basic agents, chelating agents, hydrogen peroxide agents, dispersants, and catalase agents. Thus, the geothermal power generation system 100 can supply to the re-injection line L100 the detergent that is optimum for each of ooze, calcium carbonate, amorphous silica, iron rust, and the like contained in the scale.

In the geothermal power generation system 100, the corrosive agent is one chemical agent selected from a group including a sulfuric acid, a hydrochloric acid, an acetic acid, and a citric acid. By supplying the one selected from the sulfuric acid, the hydrochloric acid, the acetic acid, and the citric acid as the corrosive agent to the re-injection line L100, the geothermal power generation system 100 elutes the iron included in the piping of the re-injection line L100, and determines the cleaning state based on the concentration of eluted iron ions.

In the geothermal power generation system 100, the dissolving agent is one chemical agent selected from a group including a basic agent, a fluoride agent, and an acidic agent. Thus, the geothermal power generation system 100 can supply the optimum dissolving agent for calcium carbonate, amorphous silica, and the like contained in the scale to the scale-piece collector 113.

In the geothermal power generation system 100, the controller 140 causes the first chemical agent adding device 130 to supply the dissolving agent, and at the same time, causes the tracer reagent to be supplied at two or more times at an interval of 5 minutes or more, and after the first liquid analyzer 111 detects the tracer reagent as many times as the number of times the tracer reagent has been supplied, stops the supply of the dissolving agent and closes the first valve V101 to execute a cleaning operation.

Thus, the controller 140 confirms the arrival of the detergent by the first liquid analyzer 111, allows the detergent to be distributed throughout the re-injection line L100, and then closes the first valve V101, thereby allowing the geothermal power generation system 100 to sufficiently contact the detergent with the inner wall of the piping of the re-injection line L100 to enhance the cleaning effect. Therefore, the geothermal power generation system 100 can more fully remove the scale of the re-injection line L100.

In the geothermal power generation system 100, after 2 to 3 hours have elapsed from the time when the first valve V101 is closed, the controller 140 opens the first valve V101, causes the first chemical agent adding device 130 to supply a corrosive agent, and determines a cleaning state based on the concentration of metal ions detected by the first liquid analyzer 111. Thus, the geothermal power generation system 100 can clean the re-injection line L100 according to the cleaning state, and can more fully remove the scale of the re-injection line L100.

In the geothermal power generation system 100, when the concentration of metal ions detected by the first liquid analyzer 111 is less than a specified value, the controller 140 determines that the cleaning is not completed, executes the cleaning operation again, and repeats the cleaning operation until the concentration of metal ions detected by the first liquid analyzer 111 reaches the specified value. Thus, the geothermal power generation system 100 can suppress occurrence of cleaning failure in the re-injection line L100, and can more fully remove the scale of the re-injection line L100.

The geothermal power generation system 100 includes the second valve V102 and the third valve V103, and when the concentration of metal ions detected by the first liquid analyzer 111 reaches the specified value and the controller 140 determines that the cleaning is completed, the controller 140 causes the geothermal brine to flow into the residue input port 113a, causes the scale-piece collector 113 to collect scale pieces, then causes the dissolving agent adding device 150 to inject a dissolving agent into the dissolving agent injection port 113b, and closes the second valve V102 and the third valve V103. In this way, in the case where the scale pieces flow through the re-injection line L100 after the cleaning of the re-injection line L100 is completed, the geothermal power generation system 100 can collect the scale pieces by the scale-piece collector 113, and remove the scale pieces by dissolving them. Therefore, the geothermal power generation system 100 can more fully remove the scale of the re-injection line L100.

In the geothermal power generation system 100, the controller 140 controls the flow of the fluid containing the dissolved scale pieces in the scale-piece collector to the re-injection well 4 via the first pipe L101 by closing the second valve V102 and the third valve V103, leaving the second valve V102 and the third valve V103 closed for 48 hours or more, and then opening the second valve V102. The controller 140 immerses the scale pieces collected by the scale-piece collector 113 into the dissolving agent under an environment maintained at a high temperature by receiving sensible heat of the re-injection well 4, such that the geothermal power generation system 100 can more fully dissolve and remove the scale pieces. Therefore, the geothermal power generation system 100 can more fully remove the scale of the re-injection line L100.

In the geothermal power generation system 100, the controller 140 controls the discharge of scale pieces remaining in the scale-piece collector to the outside through the residue discharge port 113c. Thus, the controller 140 can remove poorly soluble scale pieces that cannot be dissolved by the dissolving agent in the scale-piece collector 113.

### Third Embodiment

The geothermal power generation system 100 according to a third embodiment will be described in the following. The geothermal power generation system 100 according to the third embodiment cleans the re-injection line L100 during an ordinary operation (power generation). First, the configuration for cleaning performed in the geothermal power generation system 100 will be described.

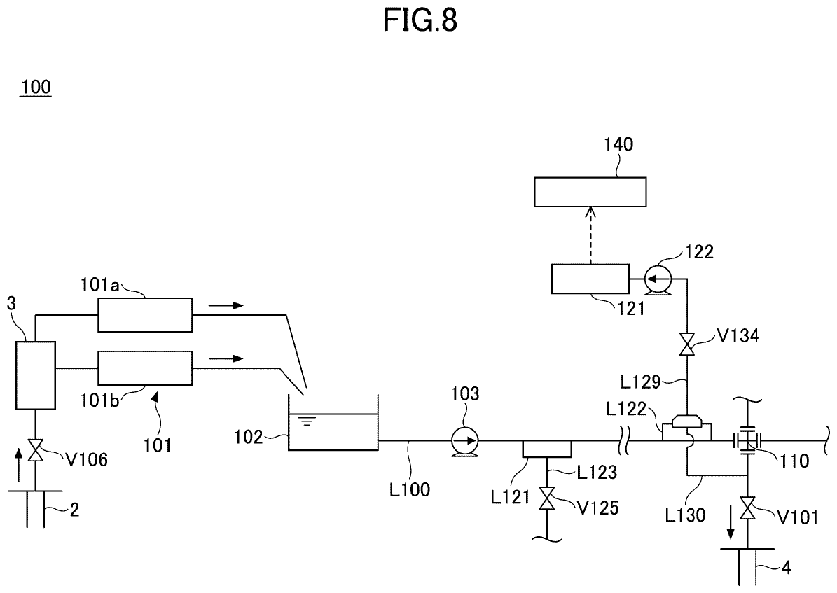

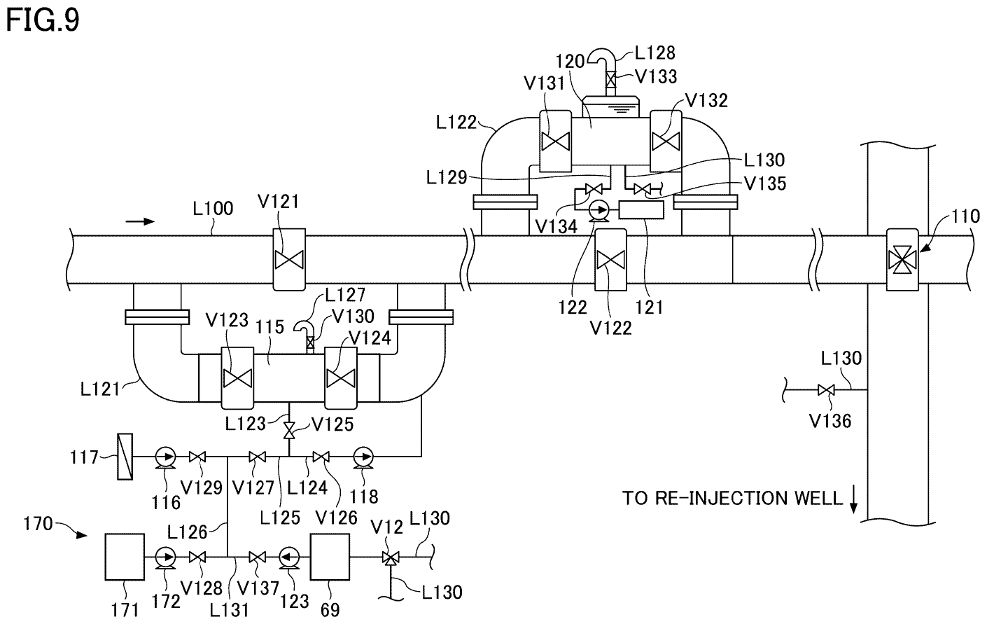

FIG. 8 is a schematic configurational diagram illustrating the geothermal power generation system according to the third embodiment, and FIG. 9 is an enlarged view illustrating main components of FIG. 8. In FIGS. 8 and 9, arrows indicate directions in which the fluid flows. The geothermal power generation system 100 may include, as illustrated in FIGS. 8 and 9, a first bypass pipe L121 branched from the re-injection line L100 and connected to the re-injection line L100 on the downstream side relative to the re-injection pump 103, and a second bypass pipe L122 branched from the re-injection line L100 and connected to the re-injection line L100 on the downstream side relative to the first bypass pipe L121. Furthermore, the geothermal power generation system 100 may include a first switching valve V121 provided in the re-injection line L100 and configured to switch a flow path of the re-injection line L100 to the first bypass pipe L121, and a second switching valve V122 provided in the re-injection line L100 and configured to switch the flow path of the re-injection line L100 to the second bypass pipe L122.

Furthermore, the geothermal power generation system 100 may include, as illustrated in FIG. 9, a chemical agent adjusting section 115 provided in the first bypass pipe L121, a first partition valve V123 provided in the first bypass pipe L121 on the upstream side relative to the chemical agent adjusting section 115, a second partition valve V124 provided in the first bypass pipe L121 on the downstream side relative to the chemical agent adjusting section 115, a second chemical agent adding device 170, and an air introducing device 116.

The chemical agent adjusting section 115 is a first bypass pipe L121 between the first partition valve V123 and the second partition valve V124, and is a portion for introducing the air into the chemical agent inside the chemical agent adjusting section 115 and adjusting the chemical agent supplied to the re-injection line L100.

The second chemical agent adding device 170 injects the chemical agent into the chemical agent adjusting section 115. The second chemical agent adding device 170 may include a chemical agent tank 171 containing a chemical agent and a chemical agent injection pump 172 connected to the chemical agent tank 171 and discharging the chemical agent toward the chemical agent adjusting section 115. The number of the chemical agent tanks 171 is one in the example as illustrated in FIG. 9, but is not limited to this, and can be selected in accordance with the number of chemical agents to be used, and may be more than one. The number of the chemical agent injection pumps 172 can be selected in accordance with the number of the chemical agent tanks 171.

The chemical agent contained in the chemical agent tank 171 may be a detergent, or a detergent and a corrosive agent having corrosivity to metals of the re-injection line L100. The number of the chemical agent tanks 171 may be more than one, and when both a detergent and a corrosive agent are used as the chemical agents, the detergent and the corrosive agent are contained in separate chemical agent tanks 171.

The detergent is a chemical agent for removing and cleaning the scale adhered inside the piping of the re-injection line L100. As the detergent, a detergent similar to the one used in the geothermal power generation system 1 of the first embodiment as illustrated in FIG. 1 can be used.

The corrosive agent is a chemical agent to be circulated in the re-injection line L100 after cleaning, eluting metals of the piping of the re-injection line L100, and determining the cleaning state by the concentration of the eluted metal ions. As the corrosive agent, a corrosive agent similar to that in the embodiment as illustrated in FIG. 1 can be used.

The air introducing device 116 supplies air to the chemical agent inside the chemical agent adjusting section 115. Examples of the air introducing device 116 include an air compressor, a blower, and the like. The geothermal power generation system 100 may include an air filter 117 provided on the upstream side relative to the air introducing device 116, and a drain pump 118 configured to drain the geothermal brine in the chemical agent adjusting section 115.

The geothermal power generation system 100 may be provided with a ninth pipe L123 connected to the chemical agent adjusting section 115, a tenth pipe L124 branched from the ninth pipe L123 and connected to the first bypass pipe L121 on the downstream side relative to the second partition valve V124, an eleventh pipe L125 branched from the ninth pipe L123 and connected to an outlet of the air introducing device 116, and a twelfth pipe L126 branched from a place in the eleventh pipe L125 and connected to an outlet port of the chemical agent injection pump 172. The drain pump 118 is provided in the tenth pipe L124.

The ninth pipe L123 is provided extending downward in the vertical direction from the chemical agent adjusting section 115. The ninth pipe L123 sends the geothermal brine discharged from the chemical agent adjusting section 115 to the tenth pipe L124, and also sends the detergent and the air to the chemical agent adjusting section 115. The geothermal power generation system 100 may include a thirteenth pipe L127 connected to the chemical agent adjusting section 115 and provided extending upward in the vertical direction from the chemical agent adjusting section 115. The thirteenth pipe L127 discharges the air in the chemical agent adjusting section 115 to the outside and introduces the air into the chemical agent adjusting section 115. The geothermal power generation system 100 may include a fifteenth valve V130 provided in the thirteenth pipe L127 and configured to open and close a flow path of the thirteenth pipe L127.

The geothermal power generation system 100 may include: a seventh valve V125 provided in a ninth pipe L123 and configured to open and close a flow path of a ninth pipe L123; an eighth valve V126 provided on the downstream side relative to the drain pump 118 in a tenth pipe L124 and configured to open and close a flow path of a tenth pipe L124; a ninth valve V127 provided in the eleventh pipe L125 and configured to open and close a flow path of the eleventh pipe L125 on the downstream side relative to a branching point to the twelfth pipe L126; a tenth valve V129 configured to open and close a flow path on the upstream side relative to the branching point to the twelfth pipe L126; and an eleventh valve V128 provided on the downstream side relative to the chemical agent injection pump 172 in the twelfth pipe L126 and configured to open and close a flow path of the twelfth pipe L126.

The geothermal power generation system 100 may include a chemical agent collecting section 120 provided in the second bypass pipe L122, a third partition valve V131 provided in the second bypass pipe L122 on the upstream side relative to the chemical agent collecting section 120, a fourth partition valve V132 provided in the second bypass pipe L122 on the downstream side relative to the chemical agent collecting section 120, and a second liquid analyzer 121 connected to the chemical agent collecting section 120.

The chemical agent collecting section 120 is a section for collecting waste liquid containing the chemical agent after the cleaning. The second liquid analyzer 121 may be an ultrasonic flowmeter, a pressure meter, a thermometer, a bubble sensor, or the like as long as it can detect air introduced into the chemical agent. The second liquid analyzer 121 may also measure the pH, a dielectric constant, or the dissolved ion concentration.

The geothermal power generation system 100 may include a fourteenth pipe L128 connected to the chemical agent collecting section 120 and extending vertically upward, and a fifteenth pipe L129 connected to the chemical agent collecting section 120 and extending vertically downward. The fourteenth pipe L128 discharges air separated in the chemical agent collecting section 120 to the outside. The geothermal power generation system 100 may include an air vent valve V133 provided in the fourteenth pipe L128. The air vent valve V133 automatically discharges the air accumulated in the chemical agent collecting section 120. The fifteenth pipe L129 connects the chemical agent collecting section 120 and the second liquid analyzer 121, and sends the fluid in the chemical agent collecting section 120 to the second liquid analyzer 121. The geothermal power generation system 100 may include a liquid feed pump 122 provided in the fifteenth pipe L129 and configured to discharge fluid flowing through the fifteenth pipe L129 toward an inlet of the second liquid analyzer 121, and a twelfth valve V134 provided in the fifteenth pipe L129 on the upstream side relative to the liquid feed pump 122 and configured to open and close a flow path of the fifteenth pipe L129.

The geothermal power generation system 100 may further include the chemical agent recovery line L130 branched from the second bypass pipe and connected to a pipe connecting the branching section 110 and the re-injection well 4. Similarly to the example illustrated in FIG. 7, the geothermal power generation system 100 may include the waste liquid recovery section 61, the scale separator 62, the first chemical agent recovery section 63, the impurity separator 64, the second chemical agent recovery section 65, the chemical agent purifier 66, and the recycled-chemical-agent tank 69 provided in the chemical agent recovery line L130 in order from the upstream side, and the waste liquid adjusting device 67. The waste liquid adjusting device 67 is connected to each of the scale separator 62, the impurity separator 64, and the chemical agent purifier 66. Since the configuration for recovering the chemical agent in the geothermal power generation system 100 of the third embodiment includes all the configurations for recovering the chemical agent in the geothermal power generation system 100 of the second embodiment, the description of the common configuration will be omitted. Hereinafter, the configuration for recovering the chemical agent will be described only in terms different from the configuration for recovering the chemical agent in the geothermal power generation system 100 of the second embodiment.

As illustrated in FIG. 9, the geothermal power generation system 100 may be provided with a chemical agent recovery valve V135 provided in the chemical agent recovery line L130 branched from the second bypass pipe L122 on the upstream side relative to the waste liquid recovery section 61 and configured to open and close a flow path between the chemical agent collecting section 120 and the waste liquid recovery section 61, and a thirteenth valve V136 provided in the chemical agent recovery line L130 on the most downstream side of the chemical agent recovery line L130.

The geothermal power generation system 100 may be provided with a sixteenth pipe L131 branched from the twelfth pipe L126, and the recycled-chemical-agent tank 69 may be connected to the sixteenth pipe L131. The geothermal power generation system 100 may be provided with a recycled chemical agent injection pump 123 provided in the sixteenth pipe L131 and configured to discharge the recycled chemical agent, and a fourteenth valve V137 provided in the sixteenth pipe L131 on the downstream side relative to the recycled chemical agent injection pump 123 and configured to open and close a flow path of the sixteenth pipe L131.

The controller 140 may switch between an injection operation and injection stoppage of the chemical agent performed by the second chemical agent adding device 170, and between allowing air introduction and stopping air introduction performed by the air introducing device 116, based on an analysis result of the second liquid analyzer 121, and may also control the first switching valve V121, the second switching valve V122, and the first to fourth partition valves V123, V124, V131, and V132. The controller 140 may control the recycled chemical agent injection pump 123, the fourteenth valve V137, the chemical agent recovery valve V135, and the thirteenth valve V136.

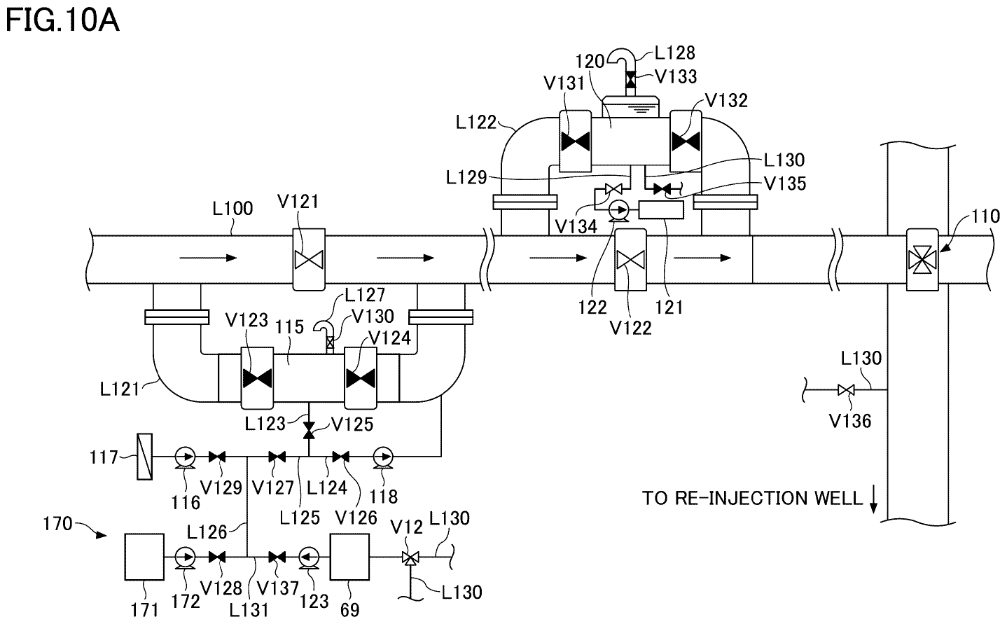

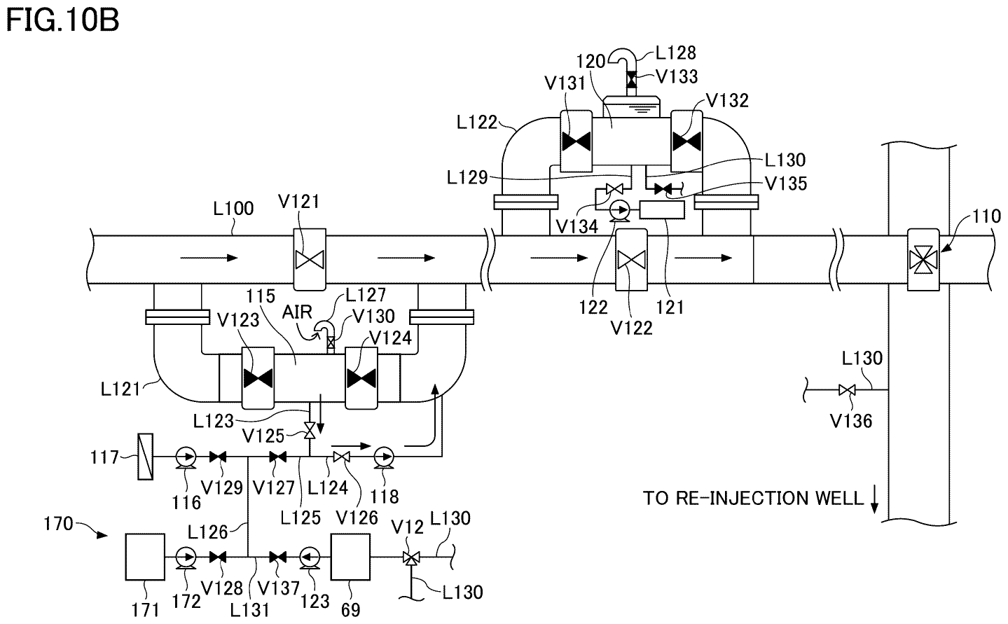

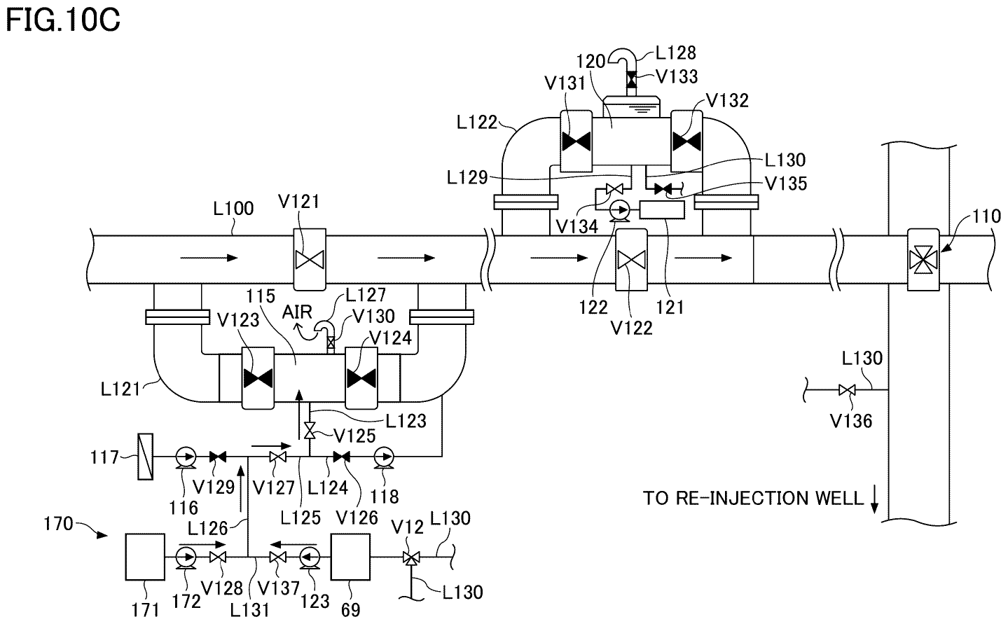

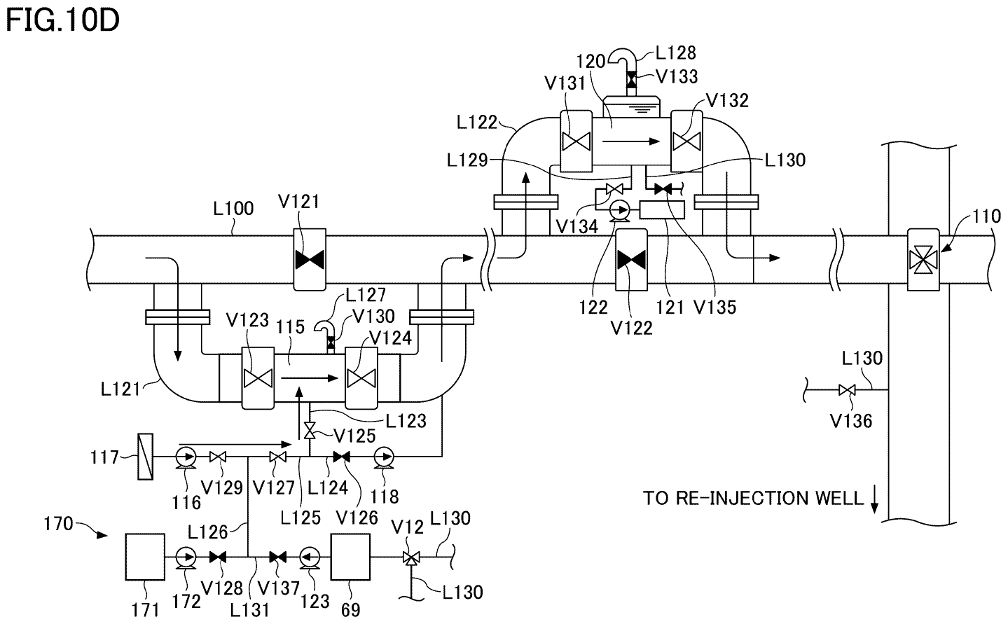

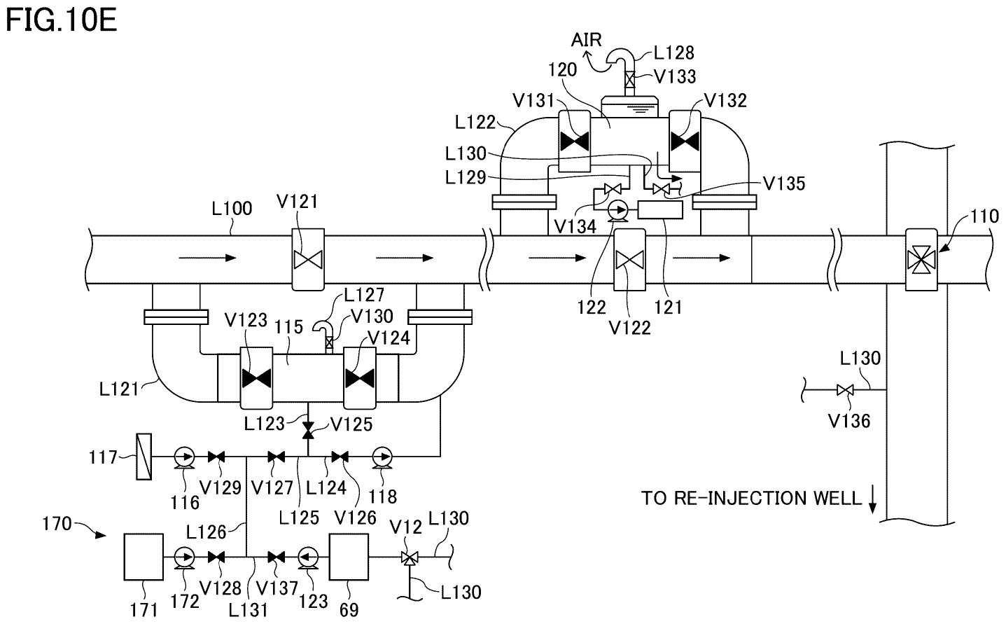

Next, operation of the cleaning in another example of the geothermal power generation system 100 of the third embodiment will be described in detail. FIGS. 10A to 10E are enlarged views of the main components of FIG. 8 for explaining the operation of cleaning in another example of the geothermal power generation system 100 according to the third embodiment. In FIGS. 10A to 10E, open valves are illustrated in white, closed valves are illustrated in black, and arrows indicate directions in which the fluid flows.

The controller 140 may repeat the ordinary operation, and after the ordinary operation, a draining operation for discharging the geothermal brine inside the chemical agent adjusting section 115, a chemical agent injection operation for injecting the chemical agent into the chemical agent adjusting section 115 from which the geothermal brine has been discharged, an air introduction operation for introducing air into the chemical agent injected into the chemical agent adjusting section 115, a line switching and cleaning operation for switching the flow path of the re-injection line L100 to the first bypass pipe L121 and the second bypass pipe L122 and starting cleaning, and a chemical agent recovery operation for recovering, after the line switching and cleaning operation, the chemical agent by circulating the waste liquid in the second bypass pipe to the chemical agent recovery line L130.

As illustrated in FIG. 10A, the controller 140 opens the first switching valve V121 and the second switching valve V122 and closes the first to fourth partition valves V123, V124, V131, and V132 in ordinary operation. In the ordinary operation, the geothermal brine flows through the re-injection line L100 and does not flow into the first bypass pipe L121 and the second bypass pipe L122.

Next, as illustrated in FIG. 10B, the controller 140 opens the seventh valve V125 and the eighth valve V126 in the draining operation for discharging the geothermal brine inside the chemical agent adjusting section 115, operates the drain pump 118, discharges the geothermal brine accumulated in the chemical agent adjusting section 115, and sends it to the first bypass pipe L121 on the downstream side relative to the second partition valve V124 via the ninth pipe L123 and the tenth pipe L124. At this time, the controller 140 opens the fifteenth valve V130, drains the geothermal brine accumulated in the chemical agent adjusting section 115, and introduces air into the chemical agent adjusting section 115 via the thirteenth pipe L127.

Next, as illustrated in FIG. 10C, in the chemical agent injection operation for injecting a chemical agent into the chemical agent adjusting section 115, the controller 140 closes the eighth valve V126, opens the ninth valve V127 and the eleventh valve V128 in addition to the seventh valve V125, operates the chemical agent injection pump 172, and starts injection of a chemical agent by the second chemical agent adding device 170. At this time, the chemical agent is injected into the chemical agent adjusting section 115, and the air in the chemical agent adjusting section 115 is discharged to the outside via the thirteenth pipe L127. At the same time, in the chemical agent injection operation for injecting a chemical agent into the chemical agent adjusting section 115, the controller 140 opens the fourteenth valve V137, operates the recycled chemical agent injection pump 123, and starts the injection operation of the recycled chemical agent contained in the recycled-chemical-agent tank 69.

Next, as illustrated in FIG. 10D, in a line switching and cleaning operation in which the flow path of the re-injection line L100 is switched to the first bypass pipe L121 and the second bypass pipe L122 and cleaning is started, the controller 140 opens the first to fourth partition valves V123, V124, V131, and V132, switches the flow path of the re-injection line L100 to the first bypass pipe L121 and the second bypass pipe L122, and controls the flow of the chemical agent in the chemical agent adjusting section 115 to the re-injection line L100 and the second bypass pipe L122.

Next, in the air introduction operation for introducing air into the chemical agent, the controller 140 closes the eleventh valve V128, the fourteenth valve V137, and the fifteenth valve V130, opens the tenth valve V129 in addition to the seventh valve V125 and the ninth valve V127. The controller 140 stops the chemical agent injection pump 172, stops the injection of the chemical agent by the second chemical agent adding device 170, operates the air introducing device 116, and controls the supply of air to the chemical agent inside the chemical agent adjusting section 115 via the ninth pipe L123 and the eleventh pipe L125.

Next, as illustrated in FIG. 10E, in the chemical agent recovery operation for recovering the chemical agent, the controller 140 causes the second liquid analyzer 121 to detect the concentration of the air contained in the waste liquid in the chemical agent collecting section 120, and when the detected concentration reaches a specified value, closes the third partition valve V131 and the fourth partition valve V132, opens the chemical agent recovery valve V135, and causes the waste liquid to flow through the chemical agent recovery line L130. The geothermal power generation system 100 can confirm that the chemical agent has arrived at the second bypass pipe L122 by causing the second liquid analyzer 121 to detect the air. In addition, the controller 140 opens the first switching valve V121 and the second switching valve V122 in the chemical agent recovery operation.

When the air introduced into the chemical agent in the chemical agent adjusting section 115 accumulates in the chemical agent collecting section 120 more than a specified value, the chemical agent is discharged to the outside through the air vent valve V133 and the fourteenth pipe L128. Furthermore, the geothermal power generation system 100 may include a deaerator (not illustrated) provided in the chemical agent recovery line L130. Examples of the deaerator include an ultrasonic deaerator, a vacuum deaerator, a centrifugal deaerator, and the like. Thus, even when the air accumulated in the chemical agent collecting section 120 cannot be entirely discharged to the outside through the air vent valve V133 and the fourteenth pipe L128, the geothermal power generation system 100 can return the geothermal brine from which the air is separated from the chemical agent recovery line L130 to the re-injection well 4 after sufficiently separating the air from the waste liquid. Therefore, the geothermal power generation system 100 can maintain the permeability of the geothermal brine returned to the re-injection well 4.

After the line switching and cleaning operation, the controller 140 repeats the ordinary operation, the draining operation, the chemical agent injection operation, the air introduction operation, the line switching and cleaning operation, and the chemical agent recovery operation again after a predetermined time elapses.

After executing the cleaning operation, the controller 140 may determine a cleaning state based on the concentration of metal ions detected by the second liquid analyzer 121 after stopping the injection of the chemical agent by the second chemical agent adding device 170 and supplying the corrosive agent by the second chemical agent adding device 170 with the first switching valve V121 and the second switching valve V122 closed and the first to fourth partition valves V123, V124, V131, and V132 opened. The concentration of metal ions detected by the second liquid analyzer 121 may be the concentration of iron ions. For example, the controller 140 may determine that the cleaning is complete when the concentration of iron ions reaches 100 ppm. The analysis result of the analysis by the second liquid analyzer 121 may be the dielectric constant.

When the concentration of metal ions detected by the second liquid analyzer 121 is less than a specified value, the controller 140 may determine that the cleaning is not complete, and repeat the ordinary operation, the draining operation, the chemical agent injection operation, the air introduction operation, and the line switching and cleaning operation again.

The controller 140 may determine that the cleaning is complete when the concentration of metal ions detected by the second liquid analyzer 121 reaches the specified value, execute the ordinary operation, and end the execution of the subsequent chemical agent injection operation, air introduction operation, and line switching and cleaning operation.

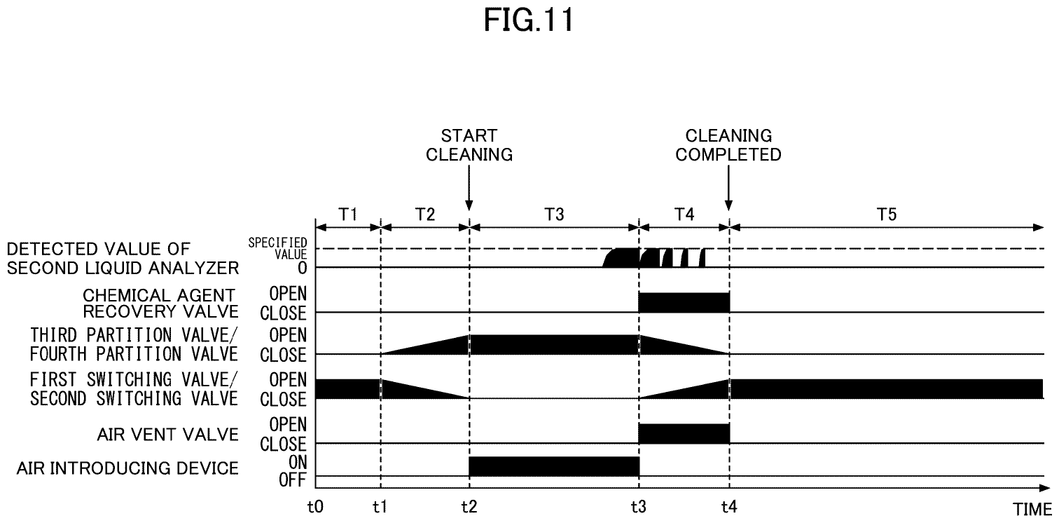

FIG. 11 is a time chart illustrating the operation of cleaning in the geothermal power generation system 100 according to the third embodiment. The time t0 is the start time of the chemical agent injection operation for injecting a chemical agent into the chemical agent adjusting section 115. At the time t0, in a state where the first switching valve V121 and the second switching valve V122 are opened, the controller 140 causes the chemical agent injection pump 172 to operate to start the operation for injecting the chemical agent by the second chemical agent adding device 170, and at the same time, causes the recycled chemical agent injection pump 123 to operate to start injection of the recycled chemical agent contained in the recycled-chemical-agent tank 69. The period T1 is the length of time required for the chemical agent injection operation to inject the chemical agent and the recycled chemical agent into the chemical agent adjusting section 115.

At the time t1 after the chemical agent injection operation, the controller 140 gradually closes the first switching valve V121 and the second switching valve V122 and gradually opens the third partition valve V131 and the fourth partition valve V132. The period T2 is the length of time required for the line switching and cleaning operation to switch the flow path of the re-injection line L100 to the first bypass pipe L121 and the second bypass pipe L122 and start cleaning.

The time t2 is the start time of the air introduction operation for introducing air into the chemical agent. The controller 140 causes the air introducing device 116 to operate at the time t2. Thus, cleaning of the re-injection line L100 starts. The period T3 is the length of time required for the air introduction operation and cleaning the re-injection line L100.

The controller 140 causes the second liquid analyzer 121 to detect the concentration of air contained in the waste liquid in the chemical agent collecting section 120, and when the detected concentration reaches the specified value, the air introducing device 116 stops at the time t3. At the same time, the controller 140 opens the chemical agent recovery valve V135 and gradually opens the first switching valve V121 and the second switching valve V122. At this time, when the amount of air in the chemical agent collecting section 120 exceeds the specified value, the air vent valve V133 is automatically opened, and the air is discharged to the outside via the fourteenth pipe L128. The period T4 is the length of time required for the chemical agent recovery operation to recover the chemical agent.

The controller 140 executes an ordinary operation at the time t4 when cleaning is completed. The period T5 is the period in which the ordinary operation is performed.

The geothermal power generation system 100 includes the first bypass pipe L121, the second bypass pipe L122, the first switching valve V121, the second switching valve V122, the chemical agent adjusting section 115, the first partition valve V123, and the second partition valve V124, the second chemical agent adding device 170, the air introducing device 116, the chemical agent collecting section 120, the third partition valve V131, the fourth partition valve V132, the second liquid analyzer 121, the chemical agent recovery line L130, the waste liquid recovery section 61, the scale separator 62, the first chemical agent recovery section 63, the impurity separator 64, the second chemical agent recovery section 65, the chemical agent purifier 66, the recycled-chemical-agent tank 69, and the waste liquid adjusting device 67, and the waste liquid adjusting device 67 is connected to each of the scale separator 62, the impurity separator 64, and the chemical agent purifier 66. Based on the analysis result of the second liquid analyzer 121, the controller 140 switches between the injection operation and injection stoppage of the chemical agent performed by the second chemical agent adding device 170, switches between allowing air introduction and stopping air introduction performed by the air introducing device 116, and controls the first switching valve V121, the second switching valve V122, and the first to fourth partition valves V123, V124, V131, and V132.

With this configuration, the geothermal power generation system 100 can clean the re-injection line L100 even during ordinary operation (power generation). The controller 140 introduces air to the chemical agent supplied by the second chemical agent adding device 170 by the air introducing device 116. Then, by controlling the first switching valve V121, the second switching valve V122, and the first to fourth partition valves V123, V124, V131, and V132, the controller 140 switches the flow path of the re-injection line L100 to the first bypass pipe L121 and the second bypass pipe L122, and distributes the chemical agent with air introduced thereto to the re-injection line L100. Thus, a contact area between the chemical agent and the geothermal brine can be reduced, and therefore the chemical can be suppressed from being diluted while flowing through the re-injection line L100. Moreover, the controller 140 can determine the cleaning state based on the concentration of metal ions detected by the second liquid analyzer 121 by supplying the corrosive agent by the second chemical agent adding device 170. Therefore, the geothermal power generation system 100 can perform cleaning until the re-injection line L100 is sufficiently cleaned. Thus, the geothermal power generation system 100 can sufficiently remove the scale of the re-injection line L100 even during an ordinary operation.

Furthermore, the waste liquid after cleaning the re-injection line L100 is adjusted by the waste liquid adjusting device 67 as the waste liquid flows through the waste liquid recovery section 61, the scale separator 62, the first chemical agent recovery section 63, the impurity separator 64, the second chemical agent recovery section 65, and the chemical agent purifier 66, and the contents of the scale and impurities are sequentially separated and then removed, and thus the waste liquid is purified. Therefore, the geothermal power generation system 1 can obtain a recycled chemical agent from the waste liquid by purifying the waste liquid, and the recycled chemical agent is stored in the recycled-chemical-agent tank 69. Thus, the geothermal power generation system 100 can sufficiently remove the scale and recover the chemical agent used for cleaning.

In the geothermal power generation system 100, the controller 140 repeats: the ordinary operation; as well as, after the ordinary operation, the draining operation for discharging the geothermal brine inside the chemical agent adjusting section 115; the chemical agent injection operation for injecting a chemical agent into the chemical agent adjusting section 115 from which the geothermal brine has been discharged; the air introduction operation for introducing air into the chemical agent injected into the chemical agent adjusting section 115; the line switching and cleaning operation for switching the flow path of the re-injection line L100 to the first bypass pipe L121 and the second bypass pipe L122 and starting cleaning; and after the line switching and cleaning operation, the chemical agent recovery operation for recovering the chemical agent by circulating the waste liquid inside the second bypass pipe to the chemical agent recovery line L14. As a result, the chemical agent containing the air is repeatedly supplied to the geothermal brine in the re-injection line L100, and the air surrounding the chemical agent becomes a barrier, making it difficult for the chemical agent to diffuse into the geothermal brine, such that the geothermal power generation system 100 can further suppress the chemical agent from being diluted while flowing through the re-injection line L100.

The geothermal power generation system 100 includes the chemical agent recovery valve V135, and the controller 40 causes the second liquid analyzer 121 to detect the concentration of the air contained in the waste liquid in the chemical agent collecting section 120, and opens the chemical agent recovery valve V135 when the detected concentration reaches a specified value. Since the geothermal power generation system 100 can confirm that the chemical has arrived at the chemical agent collecting section 120 by causing the second liquid analyzer 121 to detect the air concentration, the waste liquid containing the chemical can be sent to the chemical agent recovery line L130.

According to the geothermal power generation system according to one embodiment of the present disclosure, the scale can be sufficiently removed and the chemical used for cleaning can be recovered.

Although the embodiments have been described above, the above embodiments are presented as examples, and the present invention is not limited by the above embodiments. The above embodiments can be implemented in various other forms, and various combinations, omissions, substitutions, changes, and the like can be made without departing from the gist of the invention. These embodiments and variations thereof are included in the scope and gist of the invention, as well as in the scope and equivalence of the claimed invention.

With respect to the above embodiments, the following clauses are further disclosed.

### Clause 1

A geothermal power generation system provided with a binary power generator including a medium evaporator, comprising:
a gas-liquid separator configured to separate geothermal brine from a geothermal fluid spouted out from a production well;
a first pipe configured to send the geothermal brine separated by the gas-liquid separator to the medium evaporator;
a first valve provided in the first pipe and configured to open and close a flow path of the first pipe;
a second pipe configured to send the geothermal brine, from which heat has been recovered by the binary power generator, from the medium evaporator to a re-injection well;
an analyzer configured to intake the geothermal brine flowing through the second pipe and analyze components of scale contained in the geothermal brine that is incoming;
a controller configured to determine at least one chemical agent from a plurality of chemical agent candidates based on an analysis result of the analyzer and control supply of the chemical agent;
a chemical agent supply port provided in the first pipe on a downstream side relative to the first valve, to which the chemical agent is supplied;
a third pipe branched from the second pipe;
a chemical agent recovery line branched from the second pipe on the downstream side relative to the third pipe and connected to the second pipe;
a waste liquid recovery section provided in the chemical agent recovery line in order from an upstream side of the chemical agent recovery line, and configured to store a waste liquid after cleaning the first pipe and the second pipe;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance; a chemical agent purifier configured to purify the secondary chemical-agent-containing substance and separate the secondary chemical-agent-containing substance into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier.

### Clause 2

The geothermal power generation system according to clause 1, further comprising:
a first analyzer connected to the waste liquid recovery section and configured to measure the temperature, pH, a dielectric constant, or dissolved ion concentration of the fluid contained in the waste liquid recovery section, wherein,
the controller causes the waste liquid adjusting device to supply the silica concentration adjusting agent, the pH adjusting agent, or the ion concentration adjusting agent to the scale separator based on a measurement result of the first analyzer, or cause the waste liquid adjusting device to adjust the temperature of the fluid contained in the scale separator.

### Clause 3

The geothermal power generation system according to clause 2, further comprising:
a second analyzer connected to the first chemical agent recovery section and configured to measure the temperature, the pH, the dielectric constant, or the dissolved ion concentration of the fluid contained in the first chemical agent recovery section, wherein
based on the measurement result of the second analyzer, the controller causes the waste liquid adjusting device to supply the silica concentration adjusting agent, the pH adjusting agent, or the ion concentration adjusting agent to the impurity separator, or causes the waste liquid adjusting device to adjust the temperature of the primary chemical-agent-containing substance contained in the impurity separator.

### Clause 4

The geothermal power generation system according to clause 3, further comprising:
a third analyzer connected to the second chemical agent recovery section and configured to measure the temperature, the pH, the dielectric constant, or the dissolved ion concentration of the fluid contained in the second chemical agent recovery section, wherein
based on the measurement result of the third analyzer, the controller causes the waste liquid adjusting device to supply the silica concentration adjusting agent, the pH adjusting agent, or the ion concentration adjusting agent to the chemical agent purifier, or causes the waste liquid adjusting device to adjust the temperature of the secondary chemical-agent-containing substance contained in the chemical agent purifier.

### Clause 5

The geothermal power generation system according to clause 4, wherein
the chemical agent recovery line includes
   a first chemical agent recovery line configured to connect the waste liquid recovery section, the scale separator, the first chemical agent recovery section, the impurity separator, the second chemical agent recovery section, the chemical agent purifier, and a recycled-chemical-agent tank;
   a second chemical agent recovery line branched from the first chemical agent recovery line between the chemical agent purifier and the recycled-chemical-agent tank;
   a third chemical agent recovery line branched from the second chemical agent recovery line and connected to the chemical agent purifier; a fourth chemical agent recovery line branched from the second chemical agent recovery line and connected to the impurity separator; and
   a fifth chemical agent recovery line branched from the second chemical agent recovery line and connected to the chemical agent purifier.

### Clause 6

The geothermal power generation system according to clause 5, further comprising:
a fourth analyzer connected to the chemical agent purifier and configured to measure the concentration of the recycled chemical agent purified in the chemical agent purifier; and
a first three-way valve provided at a branching point between the first chemical agent recovery line and the second chemical agent recovery line, and configured to switch between a state in which the chemical agent purifier communicates with the recycled-chemical-agent tank and a state in which the chemical agent purifier communicates with the second chemical agent recovery line, wherein
the controller is configured to control the first three-way valve such that the chemical agent purifier communicates with the recycled-chemical-agent tank upon the concentration of the recycled chemical agent measured by the fourth analyzer reaching a specified value and determining that purification of the chemical agent is complete.

### Clause 7

The geothermal power generation system according to clause 6, further comprising:
a scale-containing substance recovery tank provided in the third chemical agent recovery line and configured to store the scale-containing substance;
a first adjusted-liquid tank provided in the third chemical agent recovery line on the downstream side relative to the scale-containing substance recovery tank and configured to store an adjusted scale-containing substance, in which silica concentration, pH, or ion concentration is adjusted; and
a fifth analyzer connected to the scale-containing substance recovery tank and configured to measure the temperature, the pH, the dielectric constant, or the dissolved ion concentration of the scale-containing substance stored in the scale-containing substance recovery tank, wherein
the controller causes the waste liquid adjusting device to supply the silica concentration adjusting agent, the pH adjusting agent, or the ion concentration adjusting agent to the scale-containing substance flowing through the third chemical agent recovery line between the scale-containing substance recovery tank and the first adjusted-liquid tank, based on the measurement result of the fifth analyzer.

### Clause 8

The geothermal power generation system according to clause 7, further comprising:
a primary-impurity recovery tank provided in the fourth chemical agent recovery line and configured to store the primary impurity;
a second adjusted-liquid tank provided in the fourth chemical agent recovery line on the downstream side relative to the primary-impurity recovery tank and configured to store an adjusted primary-impurity, in which the silica concentration, the pH, or the ion concentration is adjusted; and
a sixth analyzer connected to the primary-impurity recovery tank and configured to measure the temperature, the pH, the dielectric constant, or the dissolved ion concentration of the primary impurity stored in the primary-impurity recovery tank, wherein
the controller, based on the measurement result of the sixth analyzer, causes the waste liquid adjusting device to supply the silica concentration adjusting agent, the pH adjusting agent, or the ion concentration adjusting agent to the primary impurity flowing through the fourth chemical agent recovery line between the primary-impurity recovery tank and the second adjusted-liquid tank.

### Clause 9

The geothermal power generation system according to clause 8, further comprising:
a secondary-impurity recovery tank provided in the fifth chemical agent recovery line and configured to store the secondary impurity;
a third adjusted-liquid tank provided in the fifth chemical agent recovery line on the downstream side relative to the secondary-impurity recovery tank and configured to store an adjusted secondary-impurity, in which the silica concentration, the pH, or the ion concentration is adjusted; and
a seventh analyzer connected to the secondary-impurity recovery tank and configured to measure the temperature, the pH, the dielectric constant, or the dissolved ion concentration of the secondary impurity stored in the secondary-impurity recovery tank, wherein
the controller, based on the measurement result of the seventh analyzer, causes the waste liquid adjusting device to supply the silica concentration adjusting agent, the pH adjusting agent, or the ion concentration adjusting agent to the secondary impurity flowing through the fifth chemical agent recovery line between the secondary-impurity recovery tank and the third adjusted-liquid tank.

### Clause 10

The geothermal power generation system according to clause 9, further comprising:
an eighth analyzer connected to the first adjusted-liquid tank and configured to measure the temperature, the pH, the dielectric constant, or the dissolved ion concentration of an adjusted scale-containing substance contained in the first adjusted-liquid tank;
a residue recovery tank provided in the second chemical agent recovery line on the upstream side relative to the branching point between the fifth chemical agent recovery line and the second chemical agent recovery line; and
a second three-way valve provided at the branching point between the third chemical agent recovery line and the second chemical agent recovery line, and configured to switch between a state in which the first adjusted-liquid tank communicates with the re-injection well and a state in which the first adjusted-liquid tank communicates with the residue recovery tank, wherein
the controller controls the second three-way valve such that the first adjusted-liquid tank communicates with the re-injection well upon the concentration of the adjusted scale-containing substance measured by the eighth analyzer being within a specified range.

### Clause 11

The geothermal power generation system according to clause 10, further comprising:
a ninth analyzer connected to the second adjusted-liquid tank and configured to measure the temperature, the pH, the dielectric constant, or the dissolved ion concentration of an adjusted primary impurity contained in the second adjusted-liquid tank;
a third three-way valve provided at the branching point between the fourth chemical agent recovery line and the second chemical agent recovery line and configured to switch between a state in which the second adjusted-liquid tank communicates with the re-injection well and a state in which the second adjusted-liquid tank communicates with the residue recovery tank, wherein
the controller controls the third three-way valve such that the second adjusted-liquid tank communicates with the re-injection well upon the concentration of the adjusted primary impurity measured by the ninth analyzer being within a specified range.

### Clause 12

The geothermal power generation system according to clause 11, further comprising:
a tenth analyzer connected to the third adjusted-liquid tank and configured to measure the temperature, the pH, the dielectric constant, or the dissolved ion concentration of an adjusted secondary impurity contained in the third adjusted-liquid tank; and
a fourth three-way valve provided at the branching point between the fifth chemical agent recovery line and the second chemical agent recovery line and configured to switch between a state in which the third adjusted-liquid tank communicates with the re-injection well and a state in which the third adjusted-liquid tank communicates with the residue recovery tank, wherein
the controller controls the fourth three-way valve such that the third adjusted-liquid tank communicates with the re-injection well upon the concentration of the adjusted primary impurity measured by the tenth analyzer being within a specified range.

### Clause 13

A geothermal power generation system, comprising:
a gas-liquid separator configured to separate geothermal brine and geothermal steam from a geothermal fluid spouted out from a production well;
a power generator configured to generate power by using the geothermal brine or the geothermal steam separated by the gas-liquid separator as a heat source;
a retention tank configured to store the geothermal brine, from which heat has been recovered by the power generator;
a re-injection line configured to connect an outlet of the retention tank and the re-injection well;
a re-injection pump provided in the re-injection line and configured to return the geothermal brine discharged from the retention tank to the re-injection well;
a chemical agent injection port provided in the re-injection line between the retention tank and the re-injection pump;
a first chemical agent adding device configured to inject a chemical agent into the chemical agent injection port;
a branching section provided in the re-injection line on a downstream side relative to the re-injection pump and on an upper side in a vertical direction relative to the re-injection well, and configured to branch a flow of the geothermal brine;
a first liquid analyzer connected on the upper side in the vertical direction from the branching section;
a scale-piece collector connected in a horizontal direction from the branching section and including a residue input port, a dissolving agent injection port, and a residue discharge port;
a dissolving agent adding device configured to inject a dissolving agent into the dissolving agent injection port;
a controller configured to switch between an injection operation and injection stoppage of the chemical agent performed by the first chemical agent adding device and switch between the injection operation and injection stoppage of the dissolving agent performed by the dissolving agent adding device, based on an analysis result of the first liquid analyzer;
a chemical agent recovery line branched from a pipe connecting the dissolving agent injection port and the dissolving agent adding device and connected to a pipe connecting the branching section and the re-injection well;
a waste liquid recovery section provided in the chemical agent recovery line in order from an upstream side of the chemical agent recovery line, and configured to store a waste liquid after cleaning the re-injection line;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate the secondary chemical-agent-containing substance into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier.

### Clause 14

The geothermal power generation system according to clause 13, further comprising:
a heat exchanger configured to exchange heat between the waste liquid and a refrigerant in the waste liquid recovery section, and a heat pump configured to supply the heat that has been recovered by the heat exchanger to the scale-piece collector.

### Clause 15

The geothermal power generation system according to clause 14, further comprising:
a second analyzer connected to the first chemical agent recovery section and configured to measure the temperature, the pH, the dielectric constant, or a dissolved ion concentration of the fluid contained in the first chemical agent recovery section, wherein
the controller causes the waste liquid adjusting device to supply the silica concentration adjusting agent, the pH adjusting agent, or the ion concentration adjusting agent to the scale separator based on a measurement result of the second analyzer, or causes the waste liquid adjusting device to adjust the temperature of liquid contained in the scale separator.

### Clause 16

The geothermal power generation system according to clause 15, further comprising:
a third analyzer connected to the second chemical agent recovery section and configured to measure the temperature, the pH, the dielectric constant, or the dissolved ion concentration of the fluid contained in the second chemical agent recovery section, wherein
the controller causes the waste liquid adjusting device to supply the silica concentration adjusting agent, the pH adjusting agent, or the ion concentration adjusting agent to the chemical agent purifier based on the measurement result of the third analyzer, or causes the waste liquid adjusting device to adjust the temperature of the fluid contained in the chemical agent purifier.

### Clause 17

The geothermal power generation system according to clause 16, wherein
the chemical agent recovery line includes
   a first chemical agent recovery line configured to connect the waste liquid recovery section, the scale separator, the first chemical agent recovery section, the impurity separator, the second chemical agent recovery section, the chemical agent purifier, and the recycled-chemical-agent tank;
   a second chemical agent recovery line branched from the first chemical agent recovery line between the chemical agent purifier and the recycled-chemical-agent tank;
   a third chemical agent recovery line branched from the second chemical agent recovery line and connected to the chemical agent purifier;
   a fourth chemical agent recovery line branched from the second chemical agent recovery line and connected to the impurity separator; and
   a fifth chemical agent recovery line branched from the second chemical agent recovery line and connected to the chemical agent purifier.

### Clause 18

The geothermal power generation system according to clause 17, further comprising:
a fourth analyzer connected to the chemical agent purifier and configured to measure the concentration of the recycled chemical agent purified in the chemical agent purifier; and
a first three-way valve provided at the branching point between the first chemical agent recovery line and the second chemical agent recovery line, and configured to switch between a state in which the chemical agent purifier communicates with the recycled-chemical-agent tank and a state in which the chemical agent purifier communicates with the second chemical agent recovery line, wherein
the controller controls the first three-way valve such that the chemical agent purifier communicates with the recycled-chemical-agent tank upon the concentration of the recycled chemical agent measured by the fourth analyzer reaching a specified value and determining that the purification of the chemical agent is complete.

### Clause 19

The geothermal power generation system according to clause 18, further comprising:
a scale-containing substance recovery tank provided in the third chemical agent recovery line and configured to store the scale-containing substance;
a first adjusted-liquid tank provided in the third chemical agent recovery line on the downstream side relative to the scale-containing substance recovery tank and configured to store the scale-containing substance after adjustment; and
a fifth analyzer connected to the scale-containing substance recovery tank and configured to measure the temperature, the pH, the dielectric constant, or the dissolved ion concentration of the scale-containing substance stored in the scale-containing substance recovery tank, wherein
the controller causes the waste liquid adjusting device to supply the silica concentration adjusting agent, the pH adjusting agent, the ion concentration adjusting agent to the scale-containing substance flowing through the third chemical agent recovery line between the scale-containing substance recovery tank and the first adjusted-liquid tank, based on the measurement result of the fifth analyzer.

### Clause 20

The geothermal power generation system according to clause 19, further comprising:
a primary-impurity recovery tank provided in the fourth chemical agent recovery line and configured to store the primary impurity;
a second adjusted-liquid tank is provided on the downstream side relative to the primary-impurity recovery tank and configured to store the primary impurity after adjustment; and
a sixth analyzer is connected to the primary-impurity recovery tank and is configured to measure the temperature, the pH, a dielectric constant, or the dissolved ion concentration of the primary impurity stored in the primary-impurity recovery tank, wherein
the controller causes the waste liquid adjusting device to supply the silica concentration adjusting agent, the pH adjusting agent, or the ion concentration adjusting agent to the fluid flowing through the fourth chemical agent recovery line between the primary-impurity recovery tank and the second adjusted-liquid tank, based on the measurement result of the sixth analyzer.

### Clause 21

The geothermal power generation system according to clause 20, further comprising:
a secondary-impurity recovery tank provided in the fifth chemical agent recovery line and configured to store the secondary impurity;
a third adjusted-liquid tank is provided in the fifth chemical agent recovery line on the downstream side relative to the secondary-impurity recovery tank; and
a seventh analyzer connected to the secondary-impurity recovery tank and configured to measure the temperature, the pH, the dielectric constant, or the dissolved ion concentration of the secondary impurity stored in the secondary-impurity recovery tank, wherein
based on the measurement result of the seventh analyzer, the controller causes the waste liquid adjusting device to supply the silica concentration adjusting agent, the pH adjusting agent, or the ion concentration adjusting agent to the fluid flowing through the fifth chemical agent recovery line between the secondary-impurity recovery tank and the third adjusted-liquid tank.

### Clause 22

The geothermal power generation system according to clause 21, further comprising:
an eighth analyzer is configured to measure the temperature, the pH, the dielectric constant, or the dissolved ion concentration of an adjusted scale-containing substance contained in the first adjusted-liquid tank;
a residue recovery tank provided in the second chemical agent recovery line on the upstream side relative to a branching point between the fifth chemical agent recovery line and the second chemical agent recovery line; and
a second three-way valve provided at the branching point between the third chemical agent recovery line and the second chemical agent recovery line and configured to switch between a state in which the first adjusted-liquid tank communicates with the re-injection well and a state in which the first adjusted-liquid tank communicates with the residue recovery tank, wherein
the controller controls the second three-way valve such that the first adjusted-liquid tank communicates with the re-injection well upon the concentration of the adjusted scale-containing substance measured by the eighth analyzer being within a specified range.

### Clause 23

The geothermal power generation system according to clause 22, further comprising:
a ninth analyzer connected to the second adjusted-liquid tank and configured to measure the temperature, the pH, the dielectric constant, or the dissolved ion concentration of an adjusted primary impurity contained in the second adjusted-liquid tank; and
a third three-way valve provided at the branching point between the fourth chemical agent recovery line and the second chemical agent recovery line, and configured to switch between a state in which the second adjusted-liquid tank communicates with the re-injection well and a state in which the second adjusted-liquid tank communicates with the residue recovery tank, wherein
the controller controls the third three-way valve such that the second adjusted-liquid tank communicates with the re-injection well upon the concentration of the adjusted scale-containing substance measured by the ninth analyzer being within a specified range.

### Clause 24

The geothermal power generation system according to clause 23, further comprising:
a tenth analyzer connected to a third adjusted-liquid tank and configured to measure the temperature, the pH, the dielectric constant, or the dissolved ion concentration of an adjusted secondary impurity contained in the third adjusted-liquid tank; and
a fourth three-way valve provided at the branching point between the fifth chemical agent recovery line and the second chemical agent recovery line, and configured to switch between a state in which the third adjusted-liquid tank communicates with the re-injection well and a state in which the third adjusted-liquid tank communicates with the residue recovery tank, wherein
the controller controls the fourth three-way valve such that the third adjusted-liquid tank communicates with the re-injection well upon the concentration of the adjusted secondary impurity measured by the tenth analyzer being within a specified range.

### Clause 25

A geothermal power generation system, including:
a gas-liquid separator configured to separate geothermal brine and geothermal steam from a geothermal fluid spouted out from a production well;
a power generator configured to generate power by using the geothermal brine or the geothermal steam separated by the gas-liquid separator as a heat source;
a retention tank configured to store the geothermal brine from which heat has been recovered by the power generator;
a re-injection line configured to connect an outlet of the retention tank and a re-injection well;
a re-injection pump provided in the re-injection line and configured to return the geothermal brine discharged from the retention tank to the re-injection well;
a chemical agent injection port provided in the re-injection line between the retention tank and the re-injection pump;
a first chemical agent adding device configured to inject a chemical agent into the chemical agent injection port;
a branching section provided in the re-injection line on the downstream side relative to the re-injection pump and on an upper side in a vertical direction relative to the re-injection well, and configured to branch a flow of the geothermal brine;
a first liquid analyzer connected on an upper side in the vertical direction from the branching section;
a scale-piece collector connected in a horizontal direction from the branching section and including a residue input port, a dissolving agent injection port, and a residue discharge port;
a dissolving agent adding device configured to inject a dissolving agent into the dissolving agent injection port;
a controller configured to switch between an injection operation and injection stoppage of the chemical agent performed by the first chemical agent adding device, and switch between the injection operation and injection stoppage of the dissolving agent performed by the dissolving agent adding device, based on an analysis result of the first liquid analyzer;
a first bypass pipe branched from the re-injection line and connected to the re-injection line on the downstream side relative to the re-injection pump;
a second bypass pipe branched from the re-injection line and connected to the re-injection line on the downstream side relative to the first bypass pipe;
a first switching valve provided in the re-injection line and configured to switch a flow path of the re-injection line to the first bypass pipe;
a second switching valve provided in the re-injection line and configured to switch the flow path of the re-injection line to the second bypass pipe;
a chemical agent adjusting section provided in the first bypass pipe;
a first partition valve provided in the first bypass pipe on an upstream side relative to the chemical agent adjusting section;
a second partition valve provided in the first bypass pipe on a downstream side relative to the chemical agent adjusting section;
a second chemical agent adding device configured to inject a chemical agent into the chemical agent adjusting section;
an air introducing device configured to supply air to the chemical agent in the chemical agent adjusting section;
a chemical agent collecting section provided in the second bypass pipe;
a third partition valve provided in the second bypass pipe on the upstream side relative to the chemical agent collecting section;
a fourth partition valve provided in the second bypass pipe on the downstream side relative to the chemical agent collecting section;
a second liquid analyzer connected to the chemical agent collecting section;
a chemical agent recovery line branched from the second bypass pipe and connected to a pipe connecting the branching section and the re-injection well;
a waste liquid recovery section provided in the chemical agent recovery line in order from an upstream side of the chemical agent recovery line, and configured to store a waste liquid after cleaning the re-injection line;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate it into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier, and
the controller is configured to switch between the injection operation and injection stoppage of the chemical agent performed by the second chemical agent adding device, and between allowing air introduction and stopping air introduction performed by the air introducing device, based on an analysis result of the second liquid analyzer, as well as to control the first switching valve, the second switching valve, and the first partition valve to the fourth partition valve.

### Clause 26

The geothermal power generation system according to clause 25, wherein
the controller repeats an ordinary operation, and after the ordinary operation, a draining operation for discharging the geothermal brine inside the chemical agent adjusting section, a chemical agent injection operation for injecting the chemical agent into the chemical agent adjusting section from which the geothermal brine has been discharged, an air introduction operation for introducing air into the chemical agent injected into the chemical agent adjusting section, a line switching and cleaning operation for switching the flow path of the re-injection line to the first bypass pipe and the second bypass pipe and starting cleaning, and a chemical agent recovery operation for recovering, after the line switching and cleaning operation, the chemical agent by causing the waste liquid in the second bypass pipe to flow through the chemical agent recovery line.

### Clause 27

The geothermal power generation system according to clause 26, further comprising:
a chemical agent recovery valve provided in the chemical agent recovery line on the upstream side relative to the waste liquid recovery section and configured to open and close a flow path between the chemical agent collecting section and the waste liquid recovery section, wherein
the controller causes the second liquid analyzer to detect concentration of the air contained in the waste liquid in the second bypass pipe, and opens the chemical agent recovery valve upon the concentration which has been detected reaching a specified value.

What is claimed is:

1. A geothermal power generation system provided with a binary power generator including a medium evaporator, comprising:
a gas-liquid separator configured to separate geothermal brine from a geothermal fluid spouted out from a production well;
a first pipe configured to send the geothermal brine separated by the gas-liquid separator to the medium evaporator;
a first valve provided in the first pipe and configured to open and close a flow path of the first pipe;
a second pipe configured to send the geothermal brine, from which heat has been recovered by the binary power generator, from the medium evaporator to a re-injection well;
an analyzer configured to intake the geothermal brine flowing through the second pipe and analyze components of scale contained in the geothermal brine that is incoming;
a controller configured to determine at least one chemical agent from a plurality of chemical agent candidates based on an analysis result of the analyzer and control supply of the chemical agent;
a chemical agent supply port provided in the first pipe on a downstream side relative to the first valve, to which the chemical agent is supplied;
a third pipe branched from the second pipe;
a chemical agent recovery line branched from the second pipe on the downstream side relative to the third pipe and connected to the second pipe;
a waste liquid recovery section provided in the chemical agent recovery line in order from an upstream side of the chemical agent recovery line, and configured to store a waste liquid after cleaning the first pipe and the second pipe;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate the secondary chemical-agent-containing substance into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier.

2. The geothermal power generation system according to claim 1, further comprising:
a first analyzer connected to the waste liquid recovery section and configured to measure the temperature, pH, a dielectric constant, or a dissolved ion concentration of the fluid contained in the waste liquid recovery section, wherein,
the controller causes the waste liquid adjusting device to supply the silica concentration adjusting agent, the pH adjusting agent, or the ion concentration adjusting agent to the scale separator based on a measurement result of the first analyzer, or cause the waste liquid adjusting device to adjust the temperature of the fluid contained in the scale separator.

3. The geothermal power generation system according to claim 2, further comprising:
a second analyzer connected to the first chemical agent recovery section and configured to measure the temperature, the pH, the dielectric constant, or the dissolved ion concentration of the fluid contained in the first chemical agent recovery section, wherein
based on the measurement result of the second analyzer, the controller causes the waste liquid adjusting device to supply the silica concentration adjusting agent, the pH adjusting agent, or the ion concentration adjusting agent to the impurity separator, or causes the waste liquid adjusting device to adjust the temperature of the primary chemical-agent-containing substance contained in the impurity separator.

4. The geothermal power generation system according to claim 3, further comprising:
a third analyzer connected to the second chemical agent recovery section and configured to measure the temperature, the pH, the dielectric constant, or the dissolved ion concentration of the fluid contained in the second chemical agent recovery section, wherein
based on the measurement result of the third analyzer, the controller causes the waste liquid adjusting device to supply the silica concentration adjusting agent, the pH adjusting agent, or the ion concentration adjusting agent to the chemical agent purifier, or causes the waste liquid adjusting device to adjust the temperature of the secondary chemical-agent-containing substance contained in the chemical agent purifier.

5. The geothermal power generation system according to claim 4, wherein
the chemical agent recovery line includes
a first chemical agent recovery line configured to connect the waste liquid recovery section, the scale separator, the first chemical agent recovery section, the impurity separator, the second chemical agent recovery section, the chemical agent purifier, and a recycled-chemical-agent tank;
a second chemical agent recovery line branched from the first chemical agent recovery line between the chemical agent purifier and the recycled-chemical-agent tank;
a third chemical agent recovery line branched from the second chemical agent recovery line and connected to the chemical agent purifier;
a fourth chemical agent recovery line branched from the second chemical agent recovery line and connected to the impurity separator; and
a fifth chemical agent recovery line branched from the second chemical agent recovery line and connected to the chemical agent purifier.

6. The geothermal power generation system according to claim 5, further comprising:
a fourth analyzer connected to the chemical agent purifier and configured to measure the concentration of the recycled chemical agent purified in the chemical agent purifier; and
a first three-way valve provided at a branching point between the first chemical agent recovery line and the second chemical agent recovery line, and configured to switch between a state in which the chemical agent purifier communicates with the recycled-chemical-agent tank and a state in which the chemical agent purifier communicates with the second chemical agent recovery line, wherein
the controller is configured to control the first three-way valve such that the chemical agent purifier communicates with the recycled-chemical-agent tank upon the concentration of the recycled chemical agent measured by the fourth analyzer reaching a specified value and determining that purification of the chemical agent is complete.

7. The geothermal power generation system according to claim 6, further comprising:
a scale-containing substance recovery tank provided in the third chemical agent recovery line and configured to store the scale-containing substance;
a first adjusted-liquid tank provided in the third chemical agent recovery line on the downstream side relative to the scale-containing substance recovery tank and configured to store an adjusted scale-containing substance, in which silica concentration, pH, or ion concentration is adjusted; and
a fifth analyzer connected to the scale-containing substance recovery tank and configured to measure the temperature, the pH, the dielectric constant, or the dissolved ion concentration of the scale-containing substance stored in the scale-containing substance recovery tank, wherein
the controller causes the waste liquid adjusting device to supply the silica concentration adjusting agent, the pH adjusting agent, or the ion concentration adjusting agent to the scale-containing substance flowing through the third chemical agent recovery line between the scale-containing substance recovery tank and the first adjusted-liquid tank, based on the measurement result of the fifth analyzer.

8. The geothermal power generation system according to claim 7, further comprising:
a primary-impurity recovery tank provided in the fourth chemical agent recovery line and configured to store the primary impurity;
a second adjusted-liquid tank provided in the fourth chemical agent recovery line on the downstream side relative to the primary-impurity recovery tank and configured to store an adjusted primary-impurity, in which the silica concentration, the pH, or the ion concentration is adjusted; and
a sixth analyzer connected to the primary-impurity recovery tank and configured to measure the temperature, the pH, the dielectric constant, or the dissolved ion concentration of the primary impurity stored in the primary-impurity recovery tank, wherein
the controller, based on the measurement result of the sixth analyzer, causes the waste liquid adjusting device to supply the silica concentration adjusting agent, the pH adjusting agent, or the ion concentration adjusting agent to the primary impurity flowing through the fourth chemical agent recovery line between the primary-impurity recovery tank and the second adjusted-liquid tank.

9. The geothermal power generation system according to claim 8, further comprising:
a secondary-impurity recovery tank provided in the fifth chemical agent recovery line and configured to store the secondary impurity;
a third adjusted-liquid tank provided in the fifth chemical agent recovery line on the downstream side relative to the secondary-impurity recovery tank and configured to store an adjusted secondary-impurity, in which the silica concentration, the pH, or the ion concentration is adjusted; and
a seventh analyzer connected to the secondary-impurity recovery tank and configured to measure the temperature, the pH, the dielectric constant, or the dissolved ion concentration of the secondary impurity stored in the secondary-impurity recovery tank, wherein
the controller, based on the measurement result of the seventh analyzer, causes the waste liquid adjusting device to supply the silica concentration adjusting agent, the pH adjusting agent, or the ion concentration adjusting agent to the secondary impurity flowing through the fifth chemical agent recovery line between the secondary-impurity recovery tank and the third adjusted-liquid tank.

10. The geothermal power generation system according to claim 9, further comprising:
an eighth analyzer connected to the first adjusted-liquid tank and configured to measure the temperature, the pH, the dielectric constant, or the dissolved ion concentration of an adjusted scale-containing substance contained in the first adjusted-liquid tank;
a residue recovery tank provided in the second chemical agent recovery line on the upstream side relative to the branching point between the fifth chemical agent recovery line and the second chemical agent recovery line; and
a second three-way valve provided at the branching point between the third chemical agent recovery line and the second chemical agent recovery line, and configured to switch between a state in which the first adjusted-liquid tank communicates with the re-injection well and a state in which the first adjusted-liquid tank communicates with the residue recovery tank, wherein
the controller controls the second three-way valve such that the first adjusted-liquid tank communicates with the re-injection well upon the concentration of the adjusted scale-containing substance measured by the eighth analyzer being within a specified range.

11. The geothermal power generation system according to claim 10, further comprising:
a ninth analyzer connected to the second adjusted-liquid tank and configured to measure the temperature, the pH, the dielectric constant, or the dissolved ion concentration of an adjusted primary impurity contained in the second adjusted-liquid tank; and
a third three-way valve provided at the branching point between the fourth chemical agent recovery line and the second chemical agent recovery line and configured to switch between a state in which the second adjusted-liquid tank communicates with the re-injection well and a state in which the second adjusted-liquid tank communicates with the residue recovery tank, wherein
the controller controls the third three-way valve such that the second adjusted-liquid tank communicates with the re-injection well upon the concentration of the adjusted primary impurity measured by the ninth analyzer being within a specified range.

12. The geothermal power generation system according to claim 11, further comprising:
a tenth analyzer connected to the third adjusted-liquid tank and configured to measure the temperature, the pH, the dielectric constant, or the dissolved ion concentration of an adjusted secondary impurity contained in the third adjusted-liquid tank; and
a fourth three-way valve provided at the branching point between the fifth chemical agent recovery line and the second chemical agent recovery line and configured to switch between a state in which the third adjusted-liquid tank communicates with the re-injection well and a state in which the third adjusted-liquid tank communicates with the residue recovery tank, wherein
the controller controls the fourth three-way valve such that the third adjusted-liquid tank communicates with the re-injection well upon the concentration of the adjusted primary impurity measured by the tenth analyzer being within a specified range.

13. A geothermal power generation system, comprising:
a gas-liquid separator configured to separate geothermal brine and geothermal steam from a geothermal fluid spouted out from a production well;
a power generator configured to generate power by using the geothermal brine or the geothermal steam separated by the gas-liquid separator as a heat source;
a retention tank configured to store the geothermal brine, from which heat has been recovered by the power generator;
a re-injection line configured to connect an outlet of the retention tank and the re-injection well;
a re-injection pump provided in the re-injection line and configured to return the geothermal brine discharged from the retention tank to the re-injection well;
a chemical agent injection port provided in the re-injection line between the retention tank and the re-injection pump;
a first chemical agent adding device configured to inject a chemical agent into the chemical agent injection port;
a branching section provided in the re-injection line on a downstream side relative to the re-injection pump and on an upper side in a vertical direction relative to the re-injection well, and configured to branch a flow of the geothermal brine;
a first liquid analyzer connected on the upper side in the vertical direction from the branching section;
a scale-piece collector connected in a horizontal direction from the branching section and including a residue input port, a dissolving agent injection port, and a residue discharge port;
a dissolving agent adding device configured to inject a dissolving agent into the dissolving agent injection port;
a controller configured to switch between an injection operation and injection stoppage of the chemical agent performed by the first chemical agent adding device and switch between the injection operation and injection stoppage of the dissolving agent performed by the dissolving agent adding device, based on an analysis result of the first liquid analyzer;
a chemical agent recovery line branched from a pipe connecting the dissolving agent injection port and the dissolving agent adding device and connected to a pipe connecting the branching section and the re-injection well;
a waste liquid recovery section provided in the chemical agent recovery line in order from an upstream side of the chemical agent recovery line, and configured to store a waste liquid after cleaning the re-injection line;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate the secondary chemical-agent-containing substance into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier.

14. The geothermal power generation system according to claim 13, further comprising:
a heat exchanger configured to exchange heat between the waste liquid and a refrigerant in the waste liquid recovery section, and a heat pump configured to supply the heat that has been recovered by the heat exchanger to the scale-piece collector.

15. The geothermal power generation system according to claim 14, further comprising:
a second analyzer connected to the first chemical agent recovery section and configured to measure the temperature, the pH, the dielectric constant, or the dissolved ion concentration of the fluid contained in the first chemical agent recovery section, wherein
the controller causes the waste liquid adjusting device to supply the silica concentration adjusting agent, the pH adjusting agent, or the ion concentration adjusting agent to the scale separator based on a measurement result of the second analyzer, or causes the waste liquid adjusting device to adjust the temperature of liquid contained in the scale separator.

16. The geothermal power generation system according to claim 15, further comprising:
a third analyzer connected to the second chemical agent recovery section and configured to measure the temperature, the pH, the dielectric constant, or the dissolved ion concentration of the fluid contained in the second chemical agent recovery section, wherein
the controller causes the waste liquid adjusting device to supply the silica concentration adjusting agent, the pH adjusting agent, or the ion concentration adjusting agent to the chemical agent purifier based on the measurement result of the third analyzer, or causes the waste liquid adjusting device to adjust the temperature of the fluid contained in the chemical agent purifier.

17. The geothermal power generation system according to claim 16, wherein
the chemical agent recovery line includes
a first chemical agent recovery line configured to connect the waste liquid recovery section, the scale separator, the first chemical agent recovery section, the impurity separator, the second chemical agent recovery section, the chemical agent purifier, and the recycled-chemical-agent tank;
a second chemical agent recovery line branched from the first chemical agent recovery line between the chemical agent purifier and the recycled-chemical-agent tank;
a third chemical agent recovery line branched from the second chemical agent recovery line and connected to the chemical agent purifier;
a fourth chemical agent recovery line branched from the second chemical agent recovery line and connected to the impurity separator; and
a fifth chemical agent recovery line branched from the second chemical agent recovery line and connected to the chemical agent purifier.

18. The geothermal power generation system according to claim 17, further comprising:
a fourth analyzer connected to the chemical agent purifier and configured to measure the concentration of the recycled chemical agent purified in the chemical agent purifier; and
a first three-way valve provided at the branching point between the first chemical agent recovery line and the second chemical agent recovery line, and configured to switch between a state in which the chemical agent purifier communicates with the recycled-chemical-agent tank and a state in which the chemical agent purifier communicates with the second chemical agent recovery line, wherein
the controller controls the first three-way valve such that the chemical agent purifier communicates with the recycled-chemical-agent tank upon the concentration of the recycled chemical agent measured by the fourth analyzer reaching a specified value and determining that the purification of the chemical agent is complete.

19. The geothermal power generation system according to claim 18, further comprising:
a scale-containing substance recovery tank provided in the third chemical agent recovery line and configured to store the scale-containing substance;
a first adjusted-liquid tank provided in the third chemical agent recovery line on the downstream side relative to the scale-containing substance recovery tank and configured to store the scale-containing substance after adjustment; and
a fifth analyzer connected to the scale-containing substance recovery tank and configured to measure the temperature, the pH, the dielectric constant, or the dissolved ion concentration of the scale-containing substance stored in the scale-containing substance recovery tank, wherein
the controller causes the waste liquid adjusting device to supply the silica concentration adjusting agent, the pH adjusting agent, the ion concentration adjusting agent to the scale-containing substance flowing through the third chemical agent recovery line between the scale-containing substance recovery tank and the first adjusted-liquid tank, based on the measurement result of the fifth analyzer.

20. A geothermal power generation system, including:
a gas-liquid separator configured to separate geothermal brine and geothermal steam from a geothermal fluid spouted out from a production well;
a power generator configured to generate power by using the geothermal brine or the geothermal steam separated by the gas-liquid separator as a heat source;
a retention tank configured to store the geothermal brine from which heat has been recovered by the power generator;
a re-injection line configured to connect an outlet of the retention tank and a re-injection well;
a re-injection pump provided in the re-injection line and configured to return the geothermal brine discharged from the retention tank to the re-injection well;
a chemical agent injection port provided in the re-injection line between the retention tank and the re-injection pump;
a first chemical agent adding device configured to inject a chemical agent into the chemical agent injection port;
a branching section provided in the re-injection line on the downstream side relative to the re-injection pump and on an upper side in a vertical direction relative to the re-injection well, and configured to branch a flow of the geothermal brine;
a first liquid analyzer connected on an upper side in the vertical direction from the branching section;
a scale-piece collector connected in a horizontal direction from the branching section and including a residue input port, a dissolving agent injection port, and a residue discharge port;
a dissolving agent adding device configured to inject a dissolving agent into the dissolving agent injection port;
a controller configured to switch between an injection operation and injection stoppage of the chemical agent performed by the first chemical agent adding device, and switch between the injection operation and injection stoppage of the dissolving agent performed by the dissolving agent adding device, based on an analysis result of the first liquid analyzer;
a first bypass pipe branched from the re-injection line and connected to the re-injection line on the downstream side relative to the re-injection pump;
a second bypass pipe branched from the re-injection line and connected to the re-injection line on the downstream side relative to the first bypass pipe;
a first switching valve provided in the re-injection line and configured to switch a flow path of the re-injection line to the first bypass pipe;
a second switching valve provided in the re-injection line and configured to switch the flow path of the re-injection line to the second bypass pipe;
a chemical agent adjusting section provided in the first bypass pipe;
a first partition valve provided in the first bypass pipe on an upstream side relative to the chemical agent adjusting section;
a second partition valve provided in the first bypass pipe on a downstream side relative to the chemical agent adjusting section;
a second chemical agent adding device configured to inject a chemical agent into the chemical agent adjusting section;
an air introducing device configured to supply air to the chemical agent in the chemical agent adjusting section;
a chemical agent collecting section provided in the second bypass pipe;
a third partition valve provided in the second bypass pipe on the upstream side relative to the chemical agent collecting section;
a fourth partition valve provided in the second bypass pipe on the downstream side relative to the chemical agent collecting section;
a second liquid analyzer connected to the chemical agent collecting section;
a chemical agent recovery line branched from the second bypass pipe and connected to a pipe connecting the branching section and the re-injection well;
a waste liquid recovery section provided in the chemical agent recovery line in order from an upstream side of the chemical agent recovery line, and configured to store a waste liquid after cleaning the re-injection line;
a scale separator configured to separate the waste liquid into a scale-containing substance and a primary chemical-agent-containing substance;
a first chemical agent recovery section configured to store the primary chemical-agent-containing substance;
an impurity separator configured to separate the primary chemical-agent-containing substance into a primary impurity and a secondary chemical-agent-containing substance;
a second chemical agent recovery section configured to store the secondary chemical-agent-containing substance;
a chemical agent purifier configured to purify the secondary chemical-agent-containing substance and separate it into a secondary impurity and a recycled chemical agent;
a recycled chemical agent tank configured to store the recycled chemical agent; and
a waste liquid adjusting device configured to supply a silica concentration adjusting agent, a pH adjusting agent, or an ion concentration adjusting agent, or adjust temperature of fluid contained in the scale separator, the impurity separator, or the chemical agent purifier, wherein
the waste liquid adjusting device is connected to at least one of the scale separator, the impurity separator, or the chemical agent purifier, and
the controller is configured to switch between an injection operation and injection stoppage of the chemical agent performed by the second chemical agent adding device, and between allowing air introduction and stopping air introduction performed by the air introducing device, based on an analysis result of the second liquid analyzer, as well as to control the first switching valve, the second switching valve, and the first partition valve to the fourth partition valve.
